(19) United States
(12) Patent Application Publication
(10) Pub. No.: US 2011/0261405 A1
(43) Pub. Date: Oct. 27, 2011

(54) INFORMATION PROCESSING TERMINAL AND POWER STATE MANAGEMENT APPARATUS

(75) Inventors: Shuichi Ito, Tokyo (JP); Tomoyuki Ishii, Tokyo (JP); Masayuki Yusukaga, Tokyo (JP); Tomohiro Iwase, Tokyo (JP); Syunji Kamei, Tokyo (JP)

(73) Assignee: KONICA MINOLTA BUSINESS TECHNOLOGIES, INC., Tokyo (JP)

(21) Appl. No.: 13/088,534

(22) Filed: Apr. 18, 2011

(30) Foreign Application Priority Data
Apr. 23, 2010 (JP) JP2010-100096
May 24, 2010 (JP) JP2010-118609

(51) Int. Cl. G06F 3/12

(52) U.S. Cl. 358/1.15

(57) ABSTRACT

The distance between an information processing terminal and each image forming apparatus is detected based on the position information of the information processing terminal and each image forming apparatus, and the difference in elevation and layout drawing are checked to determine whether or not the image forming apparatus is located in the same floor or room with the information processing terminal, whereby the image forming apparatus is selected, and a request to shift the power state to the power-on side is sent to the selected image forming apparatus. Further, the server device provides such power control as to acquire the information on the position and number of terminal devices in the started-up state and the information of the position of each image forming apparatus, and to select the image forming apparatus to be set to the power-on state out of plural image forming apparatuses, based on this information.

This application is based on Japanese Patent Application Nos. 2010-100096 filed on Apr. 23, 2010 and 2010-118609 filed on May 24, 2010 with Japanese Patent Office, the entire content of which is hereby incorporated by reference.

### BACKGROUND OF THE INVENTION

The present invention relates to an information processing terminal provided with a function of sending a job to an image forming apparatus such as a printer or multi-functional peripheral, and a power state management apparatus for managing the power state of the image forming apparatus.

The image forming apparatus such as a printer or multi-functional peripheral installed in an office is connected to a network such as LAN (Local Area Network), and is operated upon receipt of a printing job from an information processing terminal (terminal device or PC), such as a personal computer, connected to the network.

When a job is sent from the personal computer under the aforementioned environment, if the image forming apparatus as a destination of transmission is in the power saving mode or power-off mode, time and effort will be required to turn on the power switch, or waiting time will be required to set the image forming apparatus to the normal operation mode. This will cause a great deal of inconvenience.

One of the systems proposed to solve the aforementioned problem is a network printing system wherein a printer itself manages the state of a predetermined PC, and if any one of the PCs managed has started, the power of the printer is automatically turned on (for example, see Japanese Unexamined Patent Application Publication No. 2006-1146).

Another such system is an image forming system wherein a request for response is sent to a PC on the network on a predetermined cycle, and the system controls the on-off state of the image forming apparatus in conformity to the result of the response (for example, see Japanese Unexamined Patent Application Publication No. 2006-259181).

In a system wherein the correspondence between the PC to be managed and the image forming apparatus is predetermined, for example, when the PC is a portable notebook PC located far away from the pre-registered image forming apparatus, the image forming apparatus located far away will be set to the normal operation mode synchronously when the PC power is turned on. Thus, even if an image forming apparatus is located at a closer position, the power must be turned on manually if the power of the image forming apparatus is off. This has raised a problem of insufficient usability in the conventional art.

The same problem occurs to the system wherein a request for response is sent to the PC on the network on a predetermined cycle, if the PC having replied is located far away from the image forming apparatus.

As another problem, when a network is linked with plural image forming apparatuses, if all the image forming apparatuses are set to the power-on state (enabled state) at all times, power will be wasted by the image forming apparatuses not often used, with the result that the operation efficiency of the image forming apparatus is reduced.

To solve this problem, a proposal has been made of a technique wherein, in a printing system linked with plural terminal devices, plural printers and a server device, the server device performs the power control (on/off control) of the printers, based on the number of the linked terminal devices or the number of printing jobs. To put it in more detail, in this technique, the appropriate number of the working printers is determined and power control of each printer is performed so that that number of printers can be put into operation, whereby power consumption of the entire system is minimized and printer operation efficiency is enhanced (for example, see Japanese Unexamined Patent Application Publication No. Hei 11-219275).

The power control of an image forming apparatus (printer) based on the number of linked terminal devices or the number of printing jobs does not take into account the positional relationship between the terminal device and image forming apparatus. Therefore, there is a possibility that, even if an image forming apparatus is installed close to the terminal device wherein a job has been inputted, the power of the image forming apparatus located far away will be turned on, and that image forming apparatus may have to be used. This will cause a great deal of inconvenience to the user.

The present invention is intended to solve the aforementioned problems. It is accordingly an object of this invention to provide an information processing terminal and power state management apparatus capable of turning on the power of the image forming apparatus located at a place convenient for use based on the current position of the information processing terminal.

Another object of the present invention is to provide a power state management apparatus capable of turning on the power of the image forming apparatuses which are located at a place convenient for use based on the position of the terminal devices in the started-up state, and whose number is optimized based on the number of terminal devices in the started-up state.

### SUMMARY

To achieve at least one of the abovementioned objects, an information processing terminal and power state management apparatus reflecting one aspect of the present invention includes following.

[1] A power state management apparatus including:

a first position information acquiring section for acquiring information on a position of an information processing terminal in a started-up state, which includes a function of sending a job to an image forming apparatus through a network;

a second position information acquiring section for acquiring information on a position of each of image forming apparatuses linked to the network;

a selecting section for selecting the image forming apparatus in which a power state is to be changed to a power-on side from among the image forming apparatuses, based on the information on the position of the information processing terminal in the started-up state acquired by the first position information acquiring section and the information on the position of each of the image forming apparatuses acquired by the second position information acquiring section; and

a transmission section for sending a request to change the power state to the image forming apparatus selected by the selecting section.

[2] A power state management apparatus including:

a first acquiring section for acquiring information on a position and a number of terminal devices in a started-up state which have a function of sending a job to an image forming apparatus through a network;

a second acquiring section for acquiring information on a position of a plurality of image forming apparatuses linked to the network; and

a control section for selecting the image forming apparatus to be turned on from among the plurality of image forming apparatuses and for providing power control of turning on the selected image forming apparatus, based on the information on the position and the number of the terminal devices in the started-up state acquired by the first acquiring section, and the information on the position of each of the plurality of image forming apparatuses acquired by the second acquiring section.

[3] An information processing terminal having a function of sending a job to an image forming apparatus through a network, the information processing terminal including:

a detecting section for detecting a distance between the information processing terminal and each of image forming apparatuses linked to the network;

a selecting section for selecting the image forming apparatus in which a power state is to be changed to a power-on side from among the image forming apparatuses, based on the distance detected by the detecting section; and

a transmission section for sending a request to change the power state to the image forming apparatus selected by the selecting section.

### BRIEF DESCRIPTION OF THE DRAWINGS

FIG. 1 is an explanatory diagram showing the system configuration and information flow in a first Example.

FIG. 2 is a block diagram showing the general configuration of an image forming apparatus in an Example of the present invention.

FIG. 3 is an explanatory diagram showing an example of the possible power state transition table for the image forming apparatus listing up power states which are possible to shift.

FIG. 4 is a block diagram showing a general configuration of the information processing terminal in the present Example.

FIG. 5 is a flow chart showing the operation of the information processing terminal regarding transmission of power state transition request.

FIG. 6 is an explanatory diagram showing the layout of the floors on the first and second floors, and the arrangement of the image forming apparatuses and information processing terminal.

FIG. 7 is an explanatory diagram showing an example of the priority table for determining the priority order with consideration given to the difference in elevation.

FIG. 8 is an explanatory diagram showing the layout of the floor provided with a room A, room B and passage, and the arrangement of the image forming apparatuses and information processing terminal.

FIG. 9 is an explanatory diagram showing an example of the registration contents of the database where the areas of the rooms A and B are defined.

FIG. 10 is an explanatory diagram showing an example of the installation area list 64 showing the information on the position and installation area of the information processing terminal and image forming apparatuses A and B.

FIG. 11 is a flow chart showing the operation for determining selection of the closest image forming apparatus by the fourth selection determining method in the operation of the information processing terminal related to transmission of the power state transition request.

FIG. 12 is an explanatory diagram showing the layout of the floor provided with the rooms A and B and passage, and the arrangement of the image forming apparatus and information processing terminal.

FIG. 13 is an explanatory diagram showing an example of the priority order table listing up the radio wave intensity and priority order of the image forming apparatuses A, B and C.

FIG. 14 is a flow chart showing the operation of the information processing terminal for sending the power state transition request when selecting to which power state the request for transition should be made, in conformity to the power state of transition destination specified by the user and the power state of the image forming apparatus.

FIG. 15 is a flow chart showing the processing when the power state of the closest image forming apparatus is 3.

FIG. 16 is a flow chart showing the processing when the power state of the closest image forming apparatus is 2.

FIG. 17 is a flow chart showing the processing when the power state of the closest image forming apparatus is 1.

FIG. 18 is an explanatory diagram showing the system configuration and information flow in the second Example.

FIG. 19 is a diagram showing the system configuration in the third Example of the present invention.

FIG. 20 is a block diagram showing the general configuration of the image forming apparatus in a third Example of the present invention.

FIG. 21 is a block diagram showing the general configuration of the terminal device in the third Example of the present invention.

FIG. 22 is a block diagram showing the general configuration of the server device in the third Example of the present invention.

FIG. 23 is a diagram showing an example of the arrangement of the image forming apparatuses and terminal devices located within the management area of the server device.

FIG. 24 is a diagram showing the database in which the device information on the image forming apparatuses A, B and C has been registered.

FIG. 25 is a diagram showing the database in which the device information on the terminal devices A, B and C has been registered.

FIG. 26 is a diagram showing the updated database of the FIG. 25, where the device information on the terminal device D has been additionally registered.

FIG. 27 is a diagram showing the updated database of the FIG. 26, where the device information on the terminal device C has been deleted.

FIG. 28 is a flow chart showing the operation when the server device has received a power-on notice from the terminal device.

FIG. 29 is a flow chart showing the operation when the server device has received a power-off notice from the terminal device.

FIG. 30 is an explanatory diagram showing the method 1 for determining the image forming apparatus when power control is to be performed.

FIG. 31 is an explanatory diagram showing the method 2 for determining the image forming apparatus when power control is to be performed.

FIG. 32 is an explanatory diagram showing the method 3 for determining the image forming apparatus when power control is to be performed.

FIG. 33 is an explanatory diagram showing the method 4 for determining the image forming apparatus when power control is to be performed.

FIG. 34 is an explanatory diagram for supplementary explanation of the method 4 for determining the image forming apparatus when power control is to be performed.

FIG. 35 is an explanatory diagram showing an example of applying the method 4 for determining the image forming apparatus when power control is to be performed.

FIG. 36 is an explanatory diagram showing the method 5 for determining the image forming apparatus when power control is to be performed.

FIG. 37 is an explanatory diagram showing an example of the method 6 for determining the image forming apparatus where power control is to be performed.

FIG. 38 is an explanatory diagram showing another example of the method 6 for determining the image forming apparatus where power control is to be performed.

FIG. 39 is a flow chart showing the detailed operation in the power control of the image forming apparatus conducted by the server device.

FIG. 40 is a diagram showing an example of the image forming apparatus determined to be an apparatus to be set to the power-on state with respect to the terminal devices in the started-up state within the management area in the fourth Example of the present invention.

FIG. 41 is a diagram showing another example of the image forming apparatus determined to be an apparatus to be set to the power-on state with respect to the terminal devices in the started-up state within the management area in the fourth Example of the present invention.

### DETAILED DESCRIPTION OF PREFERRED EMBODIMENT

In the aforementioned embodiment [1] of the present invention, the power state management apparatus acquires the information on the positions of the information processing terminal and each image forming apparatus, selects the image forming apparatus in which the power state is to be shifted to the power-on side, based on this positional relationship, and power state transition request is sent to the selected image forming apparatus. For example, it is also possible to calculate the linear distance between the information processing terminal and image forming apparatus based on position information and if there is any layout data, the route (path, i.e., a distance with consideration given to the wall, obstacle and level difference between floors) for walking between the information processing terminal and image forming apparatus can be calculated. Then the image forming apparatus can be selected in conformity to the calculated distance. To shift the power state to the power-on side means to cause a transition so that the power state will shift closer to the fully powered state (where power is supplied to all parts) than the current power state, if the power state can be shifted to plural levels without being restricted to the transition to the fully powered state.

In the aforementioned embodiment [2] of the invention, the power state management apparatus selects the image forming apparatus to be set to the power-on state from among plural image forming apparatuses, based on the information on the position and number of the terminal devices in the started-up state, and the information on the position of each image forming apparatus. For example, the number of the image forming apparatuses to set to the power-on state is determined based on the number of the terminal devices in the started-up state, or an image forming apparatus located close to the terminal devices in the started-up state is selected as a device to be set to power-on state, based on the position information of the terminal device in the started-up state and each image forming apparatus. The power state management apparatus provides power control in such a way as to turn the selected image forming apparatus to the power-on state. This arrangement makes it possible to turn on the power of image forming apparatuses located at a place convenient for use from the current position of the terminal devices in the started-up state, with the number of image forming apparatuses optimized (i.e., appropriate number of apparatuses) based on the number of terminal devices in the started-up state.

In the aforementioned embodiment [3] of the invention, the information processing terminal detects the distance between the information processing terminal and each image forming apparatus, selects the image forming apparatus in which the power state is to be shifted to the power-on side in conformity to the distance, and sends the power state transition request to the selected image forming apparatus. The distance to be detected may include the route (for walking) with consideration given to the wall and stairway along the way, in addition to the linear distance. It is also possible to arrange such a configuration that each image forming apparatus emits radio waves of a prescribed intensity, and the relative distance to each image forming apparatus is detected from the intensity of the radio wave received by the information processing terminal. To shift the power state to the power-on side means to cause a transition so that the power state will shift closer to the fully powered state (where power is supplied to all parts) than the current power state, if the power state can be shifted to plural levels without being restricted to the transition to the fully powered state. The peripheral image forming apparatus is defined as the image forming apparatus linked to a network (LAN) of the same domain as the information processing terminal, for example.

The following describes other embodiments:

[4] The power state management apparatus described in [1] wherein the selecting section selects the image forming apparatus closest to the information processing terminal in the started-up state.

[5] The power state management apparatus described in [1] or [4] wherein the selecting section performs the selection after priority order of a first image forming apparatus has been reduced below priority order of a second image forming apparatus, when a difference in elevation between the information processing terminal in the started-up state and the first image forming apparatus is equal to or greater than a reference value and a difference in elevation between the information processing terminal and the second image forming apparatus is smaller than the reference value.

In the aforementioned embodiment of the invention, when the differences in elevation (the perpendicular distance between the information processing terminal and image forming apparatus) exceeds the reference value, the image forming apparatus is judged to be present on a different floor. Then, the image forming apparatus is selected after the priority order of the image forming apparatus present on a different floor is reduced below that of the image forming apparatus installed on the same floor as the information processing terminal. The reference value should be determined based on the difference in elevation of each floor in the building.

[6] The power state management apparatus described in any one of the aforementioned [1], [4] and [5] wherein one or a plurality of areas are set for an real space, and the selecting section performs the selection after priority order of the image forming apparatus present in a same area as the information processing terminal in the started-up state is placed above priority order of the image forming apparatus present in another area.

In the aforementioned embodiment of the invention, the range occupied by each room in the real space is defined as an area, and the image forming apparatus is selected after the priority order of the image forming apparatus present in the same area as the information processing terminal is placed above that of the image forming apparatus present in other areas. The area is preferably defined as a three-dimensional space. When image forming apparatuses are arranged only on one floor, the area can be defined on a horizontal plane, without giving consideration to the dimension in the height direction.

[7] The power state management apparatus described in [2] wherein, one or a plurality of areas are set for an real space, and when one image forming apparatus is not closest to each of all the terminal devices in the started-up state in a prescribed area, the control section selects an intermediate image forming apparatus for the terminal devices in the started-up state as the image forming apparatus to be set to a power-on state.

In the aforementioned embodiment of the invention, the positional relationship (distance) between the terminal device in the started-up state and each image forming apparatus is used as the criterion to compare usability (convenience) with respect to each of the image forming apparatuses. Then, for the terminal device user, the image forming apparatus closest to his own terminal device is considered as the apparatus easiest to use. However, when one and the same image forming apparatus is not the closest image forming apparatus for all the terminal devices in the started-up state in a prescribed area, that is, when the image forming apparatus closest to the lint terminal device in the started-up state is different from the image forming apparatus closest to the second terminal device in the started-up state, turning on of both image forming apparatuses is not preferred from the viewpoint of power saving. Thus, the image forming apparatus located intermediate with respect to the terminal devices in the started-up state is set to power-on state.

“A prescribed area” can be all the areas under the management of the power management apparatus, or can be a part of these areas. For example, when the power management apparatus has plural rooms as a management area, the prescribed area can be the area for each room. Alternatively, the prescribed area can be the area centering the image forming apparatus. The term “intermediate” refers to the “area intermediate between” terminal devices or the “surrounding area including this area” in a broader sense, or the “intermediate position” between the terminal devices or the “vicinity of the intermediate position” in a narrower sense.

The aforementioned arrangement ensures that, out of all the terminal devices in the started-up state within a prescribed area, the image forming apparatus of a high degree of fairness from the viewpoint of distance can be turned on.

[8] The power state management apparatus described in [2] or [7] wherein, when one image forming apparatus is closest to each of a prescribed number or more of terminal devices in the started-up state, the control section selects the one image forming apparatus as the image forming apparatus to be set to a power-on state.

In the aforementioned embodiment of the invention, it is possible to turn on the image forming apparatus which is closest to each of a prescribed number or more of the terminal devices in the started-up state and which is the easiest to use for many users (a prescribed number or more of users).

If, for example, when the processing capacity of the image forming apparatus is commensurate with the processing amount of the job received from a prescribed number of terminal devices, and the number of terminal devices in the started-up state to each of which one and the same image forming apparatus is closest are below a prescribed number, the image forming apparatus is set to the power-on state, the processing capacity of the image forming apparatus will be excessive with respect to the processing amount of the job received from the less than a prescribed number of the terminal devices. This will cause the power of the image forming apparatus to be wasted and the operation efficiency to be reduced. To solve this problem, when there are a prescribed number or more of terminal devices in the started-up state to each of which one and the same image forming apparatus is closest, these image forming apparatuses are set to the power-on state. This procedure prevents the processing capacity of these image forming apparatuses from becoming excessive with respect to the number of the terminal devices in the started-up state (a prescribed number or more), and minimizes the power consumption and reduction in operation efficiency in the image forming apparatus.

[9] The power state management apparatus described in [8] wherein the image forming apparatus closest to each of the prescribed number or more of the terminal devices in the started-up state is assumed to be a specific image forming apparatus, and the second prescribed number of the terminal devices to each of which the specific image forming apparatus is closest are assumed to be attributed terminal devices, the second prescribed number being equal to or greater than the prescribed number, and the control section selects the image forming apparatus to be set to a power-on state for the terminal devices in the started-up state except all the attributed terminal devices.

In the aforementioned embodiment of the invention, if the specific image forming apparatus is put into power-on state, the capacity of processing the jobs of the number from the prescribed number to the second prescribed number of the attributed terminal devices to each of which this specific image forming apparatus is closest can be considered to have been ensured. The image forming apparatus to be set to the power-on state is separately selected for other terminal devices in the started-up state (except the attributed terminal device). The second prescribed number can be the same as the prescribed number, or greater than the prescribed number. The second prescribed number should be the maximum number of the terminal devices to be placed in charge of one image forming apparatus. When the prescribed number and the second prescribed number have been set to appropriate levels, it becomes possible to set the image forming apparatuses to the power-on state in the number which is neither too much nor too little with respect to the number of the terminal devices in the started-up state.

[10] The power state management apparatus described in [8] wherein the image forming apparatus closest to each of the prescribed number or more of the terminal devices in the started-up state is assumed to be a specific image forming apparatus, and the control section selects the image forming apparatus to be set to a power-on state for surplus terminal devices which are terminal devices to each of which a first specific image forming apparatus is closest except a second prescribed number of terminal devices, the second prescribed number being equal to or greater than the prescribed number for the first specific image forming apparatus, and for surplus terminal devices which are terminal devices to each of which a second specific image forming apparatus is closest except a second prescribed number of terminal devices, the second prescribed number being equal to or greater than the prescribed number for the second specific image forming apparatus.

In the aforementioned embodiment of the invention, when a specific image forming apparatus is put into power-on state, the capacity of processing the jobs from up to the second prescribed number of the terminal devices to each of which this specific image forming apparatus is closest can be considered to have been ensured. Thus, the image forming apparatus to be set to the power-on state is selected separately for the surplus of terminal devices exceeding the second prescribed number (surplus terminal devices) out of the terminal devices to each of which the specific image forming apparatus is closest. In this case, the image forming apparatus to be set to the power-on state is selected for the surplus terminal devices caused by the specific image forming apparatus.

[11] The power state management apparatus described in any one of [2], [7] through [10] wherein, one or a plurality of areas are set for an real space, and when one image forming apparatus is closest to each of all the terminal devices in the started-up state in a prescribed area, the control section selects the one image forming apparatus as the image forming apparatus to be set to a power-on state.

In the aforementioned embodiment of the invention, when one and the same image forming apparatus is closest to each of all the terminal devices in the started-up state in a prescribed area, that image forming apparatus is set to power-on state. To be more specific, if there is only one common image forming apparatus located closest to, and convenient for use by, each of the users of all the terminal devices in the started-up state, that image forming apparatus is set to power-on state.

[12] The power state management apparatus described in any one of [2], [7] through [11] wherein the image forming apparatus which is not closest to the terminal device in the started-up state and is away therefrom by at least a prescribed distance is excluded, by the control section, from a candidate of the image forming apparatus to be set to a power-on state in relation to the terminal device.

In the aforementioned embodiment of the invention, the image forming apparatus which is not located closest to the terminal device in the started-up state and is away therefrom by at least a prescribed distance with the aforementioned image forming apparatus being located where usability is poor, is excluded from the candidates of the image forming apparatus to be set to the power-on state in relation to the terminal device. This arrangement ensures that the image forming apparatus located where usability is poor is not set to the power-on state. However, an image forming apparatus located far away is not excluded from the candidates if it is the closest image forming apparatus.

[13] The power state management apparatus described in any one of [2], [7] through [12] wherein, if there is a change in the position or the number of the terminal devices in the started-up state acquired by the first acquiring section, the control section re-selects the image forming apparatus to be set to a power-on state, out of the plurality of image forming apparatuses, based on updated information on the position and the number of the terminal devices in the started-up state and the information on the position of each of the plurality of image forming apparatuses.

In the aforementioned embodiment of the invention, if there is a change in the position or number of the terminal devices in the started-up state, the control section re-selects the image forming apparatus to be set to the power-on state based on the updated information on the position and number. This arrangement ensures immediate reaction to a possible change.

[14] The power state management apparatus described in any one of [2], [7] through [13] wherein the control section provides power control in such a way as to ensure that, out of the plurality of image forming apparatuses, the image forming apparatus not having been selected as the image forming apparatus to be set to a power-on state is changed to a power-off state.

In the aforementioned embodiment of the invention, if, out of plural image forming apparatuses, the image forming apparatus not having been selected as the image forming apparatuses to be set to the power-on state has been turned on, they will be put into power-off state. This arrangement ensures only the selected image forming apparatuses to be turned on, and provides reliable management of the number of the image forming apparatuses set to the power-on state.

[15] The information processing terminal described in [3] wherein the detecting section includes:

a first position information acquiring section for acquiring information on a position of the information processing terminal; and

a second position information acquiring section for acquiring information on a position of the image forming apparatus,

wherein the detecting section detects the distance based on the information on the position of the information processing terminal acquired by the first position information acquiring section and the information on the position of the image forming apparatus acquired by the second position information acquiring section.

In the aforementioned embodiment of the invention, the information processing terminal acquires the information on the position of the information processing terminal (for example, coordinates information) and the information on the position of each image forming apparatus, and calculates the distance from each image forming apparatus based on the information of these positions. The distance to be calculated can be a linear distance. If there is any layout data, the data can be used to get the shortest distance for connecting between the positions of the information processing terminal and each image forming apparatus by detouring around an obstacle.

[16] The information processing terminal described in [3] or [15] wherein the selecting section selects the image forming apparatus closest to the information processing terminal.

[17] The information processing terminal described in any one of [3], [15] and [16] wherein the selecting section conducts the selection after a first image forming apparatus is given lower order of priority than a second image forming apparatus, when a difference in elevation between the information processing terminal and the first image forming apparatus is equal to or greater than a reference value and a difference in elevation between the information processing terminal and the second image forming apparatus is below the reference value.

The aforementioned embodiment of the invention is similar to that described in [5].

[18] The information processing terminal described in any one of [3], [15] and [17] wherein one or a plurality of areas are set for real space, and the selecting section performs the selection after the image forming apparatus located in a same area as the information processing terminal is given higher order of priority than the image forming apparatus located in another area.

The aforementioned embodiment of the invention is similar to that described in [6].

The following describes the Examples of the present invention with reference to drawings:

### First Example

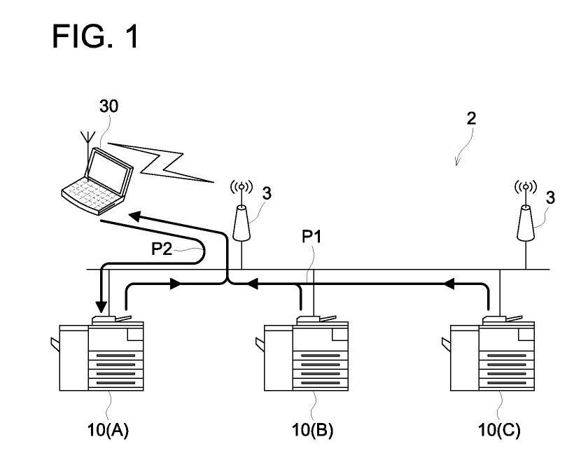

FIG. 1 shows the system configuration in a first Example. This system consists of plural image forming apparatuses 10 and an information processing terminal 30 (hereinafter also referred to as “PC”) such as a personal computer provided with a function of sending jobs to the image forming apparatus 10, linked to the network 2 such as LAN (Local Area Network) installed in an office or the like.

The network 2 includes a wired LAN and wireless LAN. The image forming apparatus 10 and information processing terminal 30 can be connected to the network 2 via either the wired LAN or wireless LAN. In this Example, the image forming apparatus 10 is assumed to be linked to the wired LAN. The network 2 is provided with plural access points 3 for wireless LANs linked with the wired LAN. The information processing terminal 30 is linked to the network 2 via the closest wireless LAN access point 3.

The Example of the present invention provides the function wherein, when the power of the information processing terminal 30 is turned on, the image forming apparatus so located as to ensure easy use from the information processing terminal 30 (e.g., the closest one) is found out of the image forming apparatuses 10 (image forming apparatuses A, B and C in FIG. 1) connectable to the information processing terminal 30 via the network 2, and a request to shift the power state to the power-on side (hereinafter referred to as “power state transition request”) is sent to this image forming apparatus.

For example, the information processing terminal 30 uses the GPS (Global Positioning System) to get the position of its own and collects the information on the position of each image forming apparatus 10 (P1). Based on this information, the information processing terminal 30 selects the image forming apparatus so located as to ensure easiest use, and sends request to set the power state to the power-on side to the selected image forming apparatus (P2).

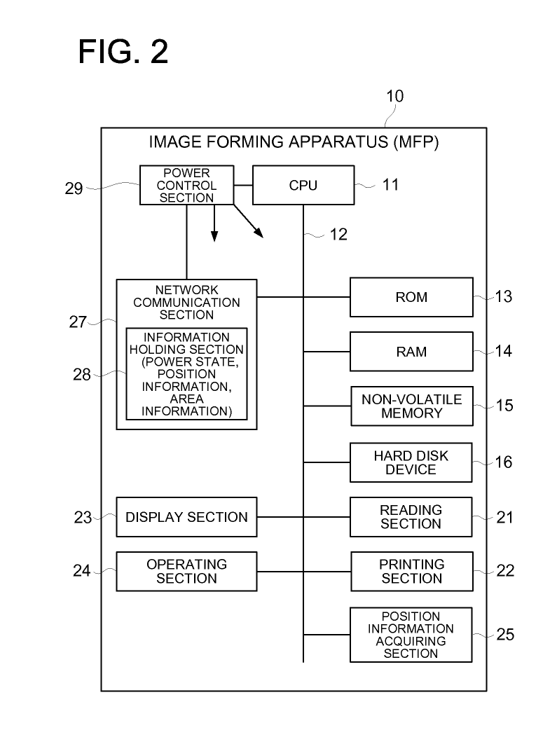

FIG. 2 shows the general configuration of the image forming apparatus 10. The image forming apparatus 10 is a so-called multi-functional peripheral provided with a copying function of optically reading a document image and printing the copied image onto a recording sheet, a scanning function of storing the read document image data as a file, and sending it to an external terminal, a printing function of forming on a recording sheet the image related to the print data received from the external terminal such as a personal computer and a facsimile transmission/reception function. The image forming apparatus 10 (hereinafter also referred to as “MFP”) can be a device capable of receiving a job from the information processing terminal 30 and executing the job. For example, it can be a printer having only the printing function or a facsimile device capable of facsimile transmission to an external device the image data received from the information processing terminal.

The image forming apparatus 10 is configured in such a way that the ROM (Read Only Memory) 13, RAM (Random Access Memory) 14, nonvolatile memory 15, hard disk device 16, reading section 21, printing section 22, display section 23, operation section 24, position information acquiring section 25 and network communication section 27 are connected to the CPU (Central Processing Unit) 11 for controlling the operation of the image forming apparatus 10 via the bus 12. The image forming apparatus 10 is further provided with the power control section 29 for controlling supply of power to various sections of the image forming apparatus 10.

The ROM 13 stores various forms of programs and fixed data, and the CPU 11 executes various forms of processing in conformity to these programs. The RAM 14 is used as a work memory for temporarily storing various forms of data or as an image memory for temporarily storing the image data when the CPU 11 executes a program.

The nonvolatile memory 15 is a rewritable memory in which the stored data remains undeleted even when power has been cut off. The nonvolatile memory 15 stores various forms of settings (set values) specified for the image forming apparatus 10, and user information.

The reading section 21 obtains the image data by optically reading out images of original documents. The reading section 21 is configured to be provided with, for example, a light source that emits light onto an original document, a line image sensor that receives the light reflected from the document and reads out one line part of the document in the width direction, an optical system that is made of lenses, mirrors or the like, and that guides the light reflected from the document to the image sensor and forms an image and a movement mechanism that successively moves the reading position for every line along the length direction of the document, by moving a mirror or a light source.

The printing section 22 prints out on a recording sheet the images based on the image data using an electro-photographic process. The printing section 22, for example, is configured to have a conveying unit for recording sheets, a photoreceptor drum, a charging device, a laser diode (LD) whose turning ON is controlled according to the image data that is inputted, a scanning unit that scans the laser light beam emitted by the laser diode (LD) on the photoreceptor drum, a developing device, a transfer and separating device, a cleaning device, and a fixing device, as a so called laser printer. This printer section can also be an LED printer in which the photoreceptor drum is scanned by an LED (Light Emitting Diode) instead of a laser light, or else, it can also be a printer of some other method.

The display section 23 carries out a function of displaying various types of operation screens, settings screens and guidance screens. The display section 23 is configured using a liquid crystal display or the like. The operation section 24 carries out a function of receiving various types of operations from the user. The operation section 24 is constructed to have various types of operation buttons such as a touch panel that is provided on the surface of the liquid crystal display and that detects the coordinates of the position where it is pressed, a start button, a stop button, ten keys.

The position information acquiring section 25 carries out a function of acquiring position information showing the installation position of the image forming apparatus 10. Here, it acquires the position information by using a GPS. It also possible to get position information of the installation of the image forming apparatus 10 by using another device such as a mobile terminal having a GPS function and to input it into the image forming apparatus 10 to be stored. That is, as it rare that the image forming apparatus 10 is moved to another place, it can be configured so that the position is detected by a separate device and the detected position information is stored in a nonvolatile memory 15 or others in the image forming apparatus 10.

The network communication section 27 communicates with the information processing terminal 30 or other external devices (for example, other image forming apparatus 10 and server) via the network 2 to receive and send various forms of data. Even when the CPU 11 and others have entered the power saving state or power-off state to suspend operations, the network communication section 27 independently operates to receive and analyzes packets and returns the required reply to the transmitter. In this case, the network communication section 27 is provided with the information holding section 28 storing the position information and the information on the current power state of the image forming apparatus 10. When the network communication section 27 has received the position information or power state acquisition request from the information processing terminal, the network communication section 27 reads the relevant information from the information holding section 28 and sends the reply.

The power control section 29 properly converts the power from the commercial power source to appropriate voltage and supplies the voltage to various parts of the image forming apparatus 10. In conformity to the instruction of the CPU 11, the power control section 29 determines whether or not power should be supplied, for each of power supply destinations.

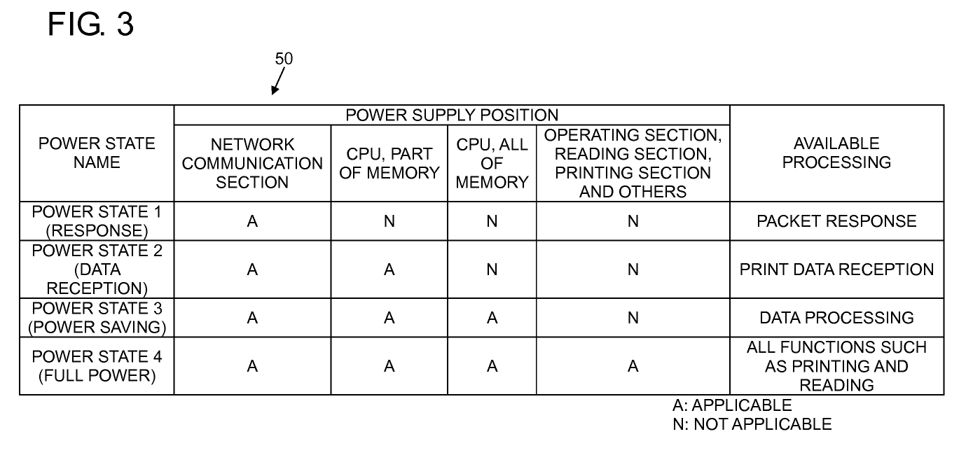

FIG. 3 shows the possible power state transition table 50 listing up power states to which the image forming apparatuses 10 can transition to. Transition to power state 1, 2, 3, or 4 is possible. In the power state 1, power is supplied to the network communication section 27 alone, and the power is kept to the minimum. In this state, packet reception, analysis and transmission are enabled. Reply can be made to the packet regarding verification of the presence from another device on the network.

In the power state 2, power consumption is considerably suppressed, and a minimum required power is supplied to the network communication section 27, CPU 11 and memory (ROM 13 and RAM 14) without any power being supplied to other places. In this state, it is possible to perform processing that does not use the performance of the CPU 11 much, or to store data in the memory. Thus, the printing data can be received from the information processing terminal and stored in the memory.

In the power state 3, power is supplied to the network communication section 27, CPU 11, ROM 13, RAM 14, and nonvolatile memory 15 and hard disk device 16 on a regular basis, but not to other portions (reading section 21, printing section 22, display section 23, operation section 24 and position information acquiring section 25). In this state, the performances of the CPU 11 can be fully employed and an image can be processing. However, a job using the reading section 21 or printing section 22 cannot be executed. Further, the display section 23 is in the display off state.

In the power state 4, power is supplied to all parts of the image forming apparatus 10 including the reading section 21, printing section 22, display section 23, operation section 24 and position information acquiring section 25. The power is maximally employed, and all functions are enabled.

The image forming apparatus 10 is designed as follows. In the power state 4, if the standby state continues over a prescribed time without execution of a job using the reading section 21 or printing section 22 or user operation, the power state automatically transitions to the power state 3. In the power state 3, if image processing or other processing is not performed over a prescribed time, the power state automatically transitions to the power state 2. In the power state 2, if there is no reception of data from an external device over a prescribed time, the power state automatically transitions to the power state 1. In the power states 2, 3 and 4, the CPU 11 is working. Thus, the CPU 11 provides management and control to determine the next power state to be assumed. In conformity to this control, the power control section 29 selects the power state for each portion. The power state 1 is turned back to the power state 2, 3 or 4, for example, based on the return signal outputted from the network communication section 27 to the power control section 29 or CPU 11.

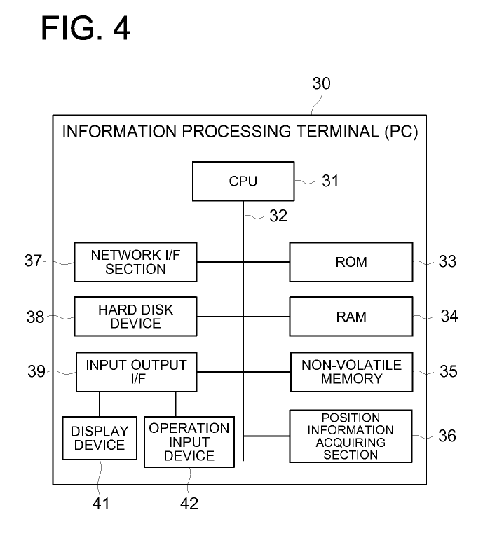

FIG. 4 shows the general configuration of the information processing terminal 30 in this Example. The information processing terminal 30 has a function of transmitting such a job as a scanning job or printing job to the image forming apparatus 10 and of requesting to execute it. The information processing terminal 30 is configured as a personal computer (PC) incorporating the OS program, driver program of the image forming apparatus 10, application program for creating and editing a document or image, power management program for controlling the power state of the image forming apparatus 10. In this case, the information processing terminal 30 is configured as a portable notebook PC.

The information processing terminal 30 has a CPU 31. The CPU 31 is connected with the ROM 33, RAM 34, nonvolatile memory 35, position information acquiring section 36, network I/F section 37, hard disk device (HDD) 38, input-output I/F 39 via the bus 32. Further, the CPU 31 is connected with a display device 41 such as a liquid crystal display, and an operation input device 42 such as a keyboard or mouse via the input-output I/F 39.

The ROM 33 stores the boot-up program and fixed data. The RAM 34 stores the program loaded from the hard disk device 38. The RAM 34 is used as a work memory for temporarily storing various data when the CPU 31 executes the program.

The nonvolatile memory 35 is the memory that ensures the stored data undamaged when the power has been turned off. This memory stores the system information (name and IP address) of the information processing terminal 30, user information and various setting information.

The position information acquiring section 36 acquires the information on the current position of the information processing terminal 30. In this case, the GPS is used to get the position information.

The network I/F section 37 exchanges various data with the image forming apparatus 10 and other external devices via the network 2. In this case, the network I/F section 37 has a function of communicating with the wireless LAN access point 3 of the network 2 through radio connection (wireless LAN function).

The hard disk device 38 is a large-capacity nonvolatile storage device, and stores the OS program, driver program of the image forming apparatus 10, power management program, various application programs, files and data.

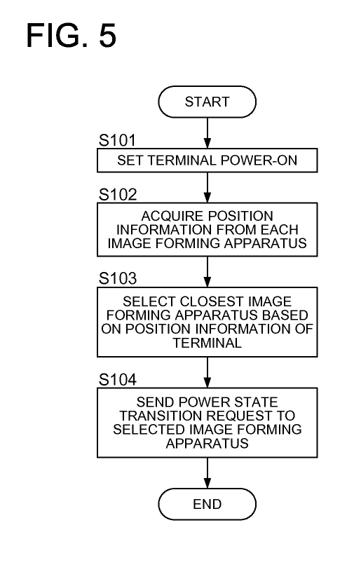

FIG. 5 shows the operation of the information processing terminal 30 regarding the transmission of the power state transition request to shift the power state of the image forming apparatus 10 to the power-on side (to the side closer to the power state 4). This operation is implemented by execution of the power management program. When the information processing terminal 30 is turned on (Step S101), the information processing terminal 30 acquires the position information from each image forming apparatus 10 that can be connected with the information processing terminal 30 via the network 2 (Step S102).

To put it in more detail, the information processing terminal 30 broadcasts the position information acquisition request over the network (LAN) 2 connected thereto. In reply to this request, the network communication section 27 of the image forming apparatus 10 having received the position information acquisition request sends the position information (and power state information when a request for it is made) stored in the information holding section 28 to the information processing terminal 30 as the transmitter of the position information acquisition request. This is received by the information processing terminal 30. As described above, the image forming apparatus 10 can send the reply to the position information acquisition request, independently of which the power state is among 1 through 4.

The information processing terminal 30 acquires the information on the current position of the information processing terminal through the position information acquiring section 36. Based on the position information of the information processing terminal and the position information of each image forming apparatus included in the reply having received from each image forming apparatus 10, the information processing terminal 30 selects and determines the image forming apparatus 10 so located as to ensure easy use from the information processing terminal (Step S103). In this case, the image forming apparatus 10 closest to the information processing terminal is selected and determined as the image forming apparatus so located as to ensure easy use from the information processing terminal. The power state transition request is sent to the selected image forming apparatus 10 (Step S104), whereby processing terminates. Having received the power state transition request, the image forming apparatus 10 shifts its power state to the power-on side (for example, to the power state 4).

The following describes the method for selecting and determining the closest image forming apparatus in the aforementioned Step S103.

(1) First Selection Determining Method

The distance (linear distance within three-dimensional space) is calculated from the position information (coordinates) of the image forming apparatus 10 and position information (coordinates) of the information processing terminal 30, and the image forming apparatus 10 of the shortest distance is selected.

(2) Second Selection Determining Method

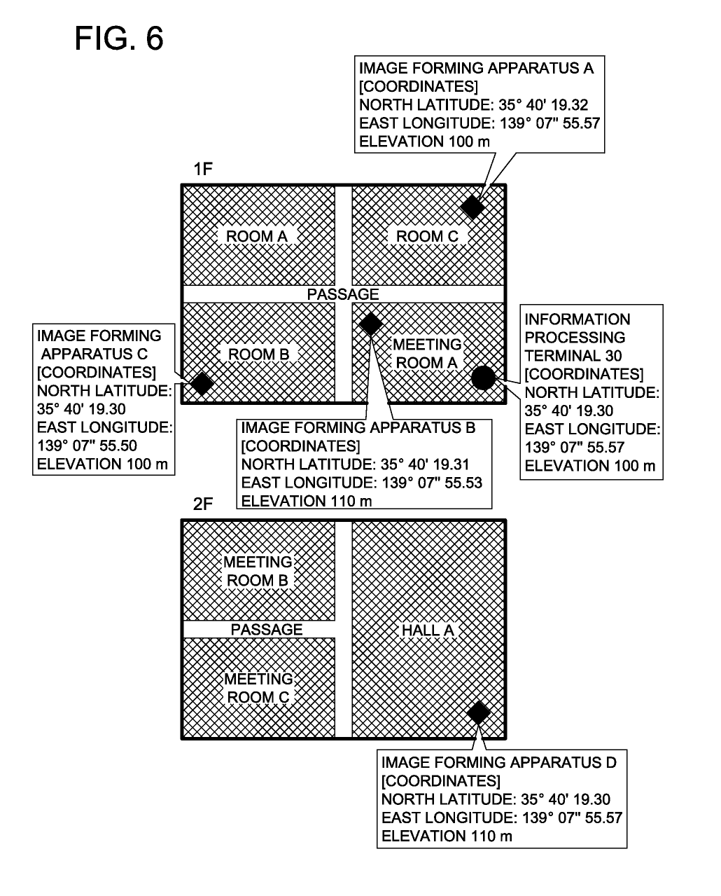

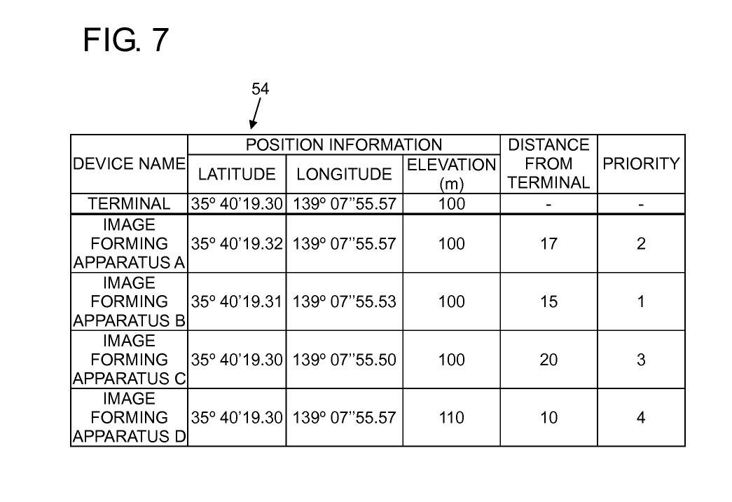

When only the distance (linear distance) by coordinates is compared for selection as in the aforementioned first selection determining method, the image forming apparatus D on a different floor will be the closest apparatus in the case of the positional relationship shown in FIG. 6, and the user will have to move a longer distance. To be more specific, the information processing terminal 30 and image forming apparatuses A, B and C are located on the same floor (1st floor) in the layout of FIG. 6. The distances are 17 meters up to the image forming apparatus A, 15 meters up to the image forming apparatus B, and 20 meters up to the image forming apparatus C, respectively (see Priority Table 54 of FIG. 7). In the meantime, although the image forming apparatus D is located on a different floor (2nd floor), it is located immediately above the information processing terminal 30, so the linear distance to the image forming apparatus D is 10 meters and the shortest, as shown in the Priority Table 54 of FIG. 7.

To solve this problem, in the second selection determining method, the priority order of the image forming apparatus 10 wherein the difference in elevation (distance in the vertical direction) between the information processing terminal 30 and image forming apparatus 10 is equal to or greater than reference value, is lowered below that of the image forming apparatus 10 wherein the difference in elevation is less than the reference value. Then selection of the closest image forming apparatus 10 is determined. In the examples shown in FIG. 6 and FIG. 7, priority is assigned to the image forming apparatuses A, B and C located on the same floor in the ascending order of distance, i.e., in such a way that the highest priority will be given to the apparatus having the shortest distance. Then priority is assigned to the image forming apparatus D on a different floor. As a result, the image forming apparatus B having the shortest distance on the same floor is selected as the closest image forming apparatus.

The reference value for determining if apparatuses are located on the same floor or not can be set at a desired value in advance. It can be determined with reference to the difference in elevation on the surface of each floor in the building where apparatuses are installed. For example, the reference value can be set to the difference in elevation on the surface of each floor, or to a value slightly smaller than the difference in elevation on the surface of each floor. If “(the difference in elevation between the information processing terminal 30 and image forming apparatus 10)/(reference value)” is calculated after the reference value is set to the difference in elevation on the surface of each floor, the integral part of the quotient thereof indicates the distance between the information processing terminal 30 and image forming apparatus 10 in terms of the number of floors. For example, if the integral part of the quotient is 0, information processing terminal 30 and image forming apparatus 10 are located on the same floor. If the integral part of the quotient is 1, information processing terminal 30 and image forming apparatus 10 are located one floor apart from each other, that is, the former device is located on the second floor, and the latter is located on the third floor for example. If the integral part is 2, information processing terminal 30 and image forming apparatus 10 are located two floors apart from each other, that is, the former device is located on the second floor, and the latter is located on the fourth floor for example. Thus, a lower order of priority order can be given as the floors are further separated. For example, if there is an image forming apparatus 10 one floor apart (for example, 20 meters away in terms of linear distance) and an image forming apparatus 10 two floors apart (for example, 15 meters away in terms of linear distance) without any image forming apparatus located on the same floor, priority is given to the image forming apparatus 10 one floor apart at the time of selection.

(3) Third Selection Determining Method

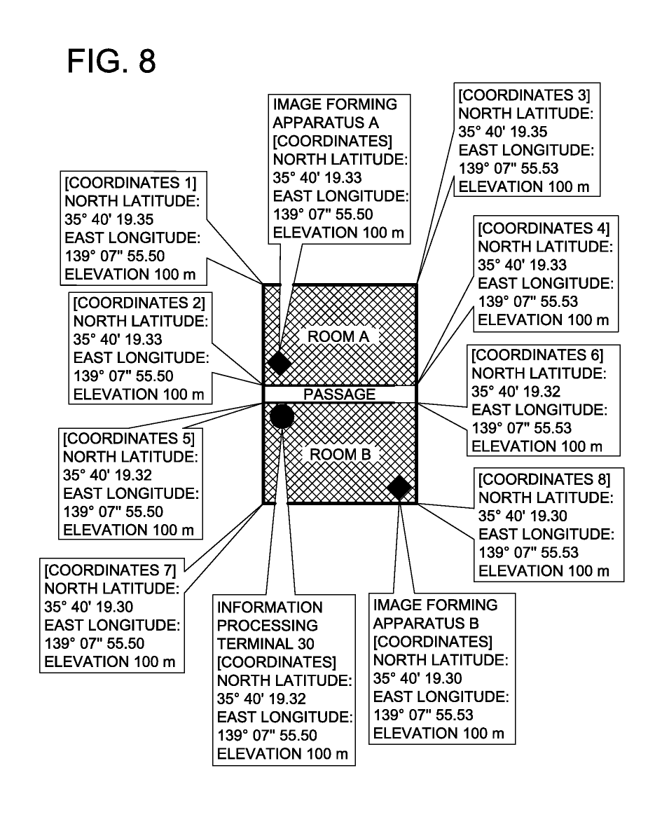

If an image forming apparatus of the shortest distance (linear distance) is selected in terms of the positional relationship shown in FIG. 8, the image forming apparatus A will be selected. However, in the positional relationship of FIG. 8, a wall is found between the information processing terminal 30 and image forming apparatus A, and the user will have to walk a longer distance. Not only that, he has to move to another room, and he may not be given permission to enter.

To solve this problem, in the third selection determining method, the occupied area such as a room in the real space is registered as an area defined in terms of coordinates of four corners (latitude, longitude and elevation), for example. Then the priority order of the image forming apparatus 10 located in the same area as the information processing terminal 30 is raised over that of the image forming apparatus 10 in another area, and the closest image forming apparatus is selected. If the area is defined in terms of plane surface, the height of the area can be considered invariably to be a prescribed value (for example, 7 m). If areas of different elevations are defined within the range of the same latitude and longitude, the elevation of the lower area up to the elevation of the upper area can be considered as the height on the lower area. Further, the height can be set for each area and the area can be defined as a three-dimensional space. The area can be defined by any desired method, without being restricted to the method of setting four-corner coordinates. For example, the coordinates of five or more points can be used for this definition. A circular or cylindrical area can be defined.

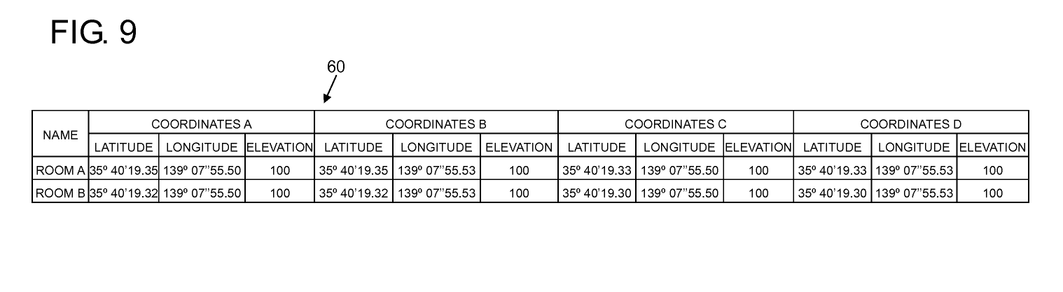

FIG. 9 shows an example of the registration in the database 60 where the areas of rooms A and B of FIG. 8 are defined and registered in terms of four-corner coordinates A, B, C and D. By comparison between the information registered in the database 60 and the position information on the information processing terminal 30 and image forming apparatus 10, the information processing terminal 30 determines the area where each apparatus is located.

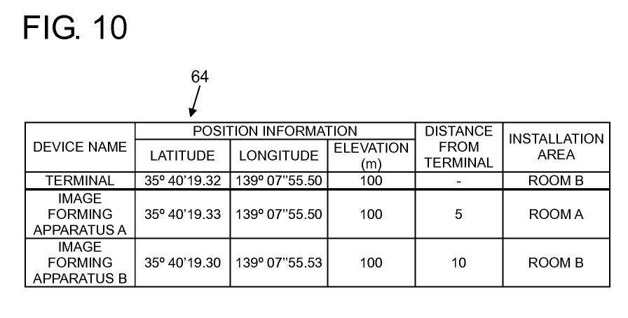

For example, in the layout of FIG. 8, comparison with the database 60 of FIG. 9 identifies the area where the information processing terminal 30 and image forming apparatuses 10 are installed. This allows the installation area list 64 of FIG. 10 to be created. The information area list 64 of FIG. 10 reveals that the information processing terminal 30 is located in the room B, the image forming apparatus A is in the room A, and the image forming apparatus B is in the room B. The information processing terminal 30 makes selection by giving a higher order of priority to the image forming apparatus located in the same area (installation area) as the information processing terminal 30 than the apparatuses in other areas. In the example of FIG. 10, the image forming apparatus B located in the room B which is the same as the information processing terminal 30 is selected as the closest image forming apparatus.

Any storage site can be used to store the database 60. For example, the information processing terminal 30, each image forming apparatus 10 or a separate server can be used to store the database 60. When the database is stored in other devices than the information processing terminal 30, the information processing terminal 30 acquires the area information from the storage site.

The following describes the fourth selection determining method for determining the selection of the closest image forming apparatus (the image forming apparatus located to ensure easy use), without using the position information:

In the configuration of using the fourth selection determining method, the image forming apparatus 10 is provided with a radio wave transmitting section for emitting the radio wave carrying the identification information of its own device (for example, device number), instead of the position information acquiring section 25. The radio wave carrying the identification information is emitted non-directionally, for example. Further, all the image forming apparatuses 10 emit the signal at the same radio wave intensity. The information processing terminal 30 is provided with a radio wave receiving section instead of a position information acquiring section 36.

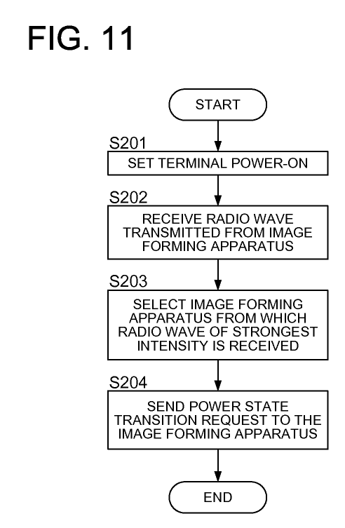

FIG. 11 shows the flow of operation in the information processing terminal 30 where selection of an image forming apparatus is determined by the fourth selection determining method and the power state transition request is sent. When power is turned on (Step S201), the information processing terminal 30 receives the radio wave sent from each image forming apparatus 10 (Step S202), and the image forming apparatus as a transmitter of the radio wave having the greatest intensity is selected as the image forming apparatus 10 (the closest image forming apparatus) which is the sending destination of the power state transition request (Step S203). Then the power state transition request is sent to the selected image forming apparatus 10 (Step S204), whereby processing terminates.

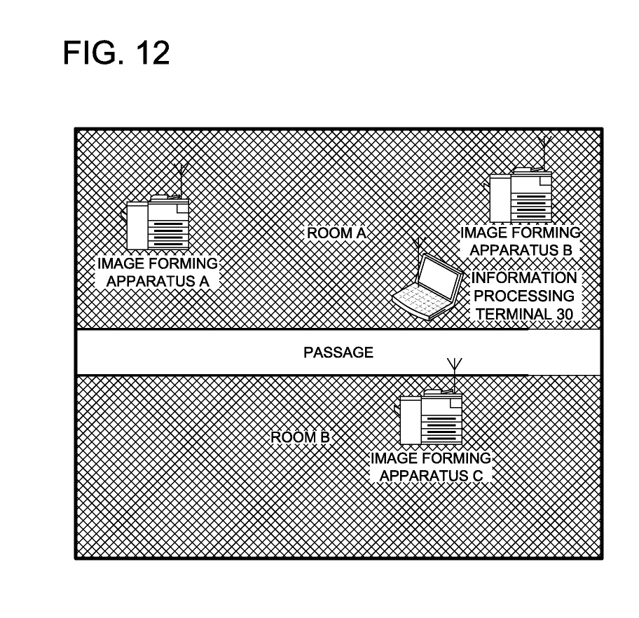

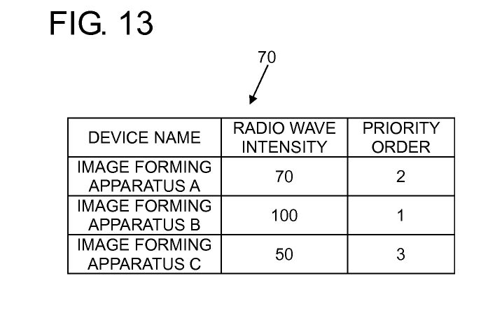

In the positional relationship of FIG. 12, the intensities of the radio wave received by the information processing terminal 30 are ordered as illustrated in the Priority Order Table 70 of FIG. 13. To be more specific, the highest intensity is that of the radio wave coming from the image forming apparatus B located at a short distance in the same room A as the information processing terminal 30. Further, the image forming apparatus C is located at a shorter distance than the image forming apparatus A. However, since the image forming apparatus C is located in the room B with a wall sandwiched in-between, the radio wave intensity is lower. Thus, the radio intensity of the image forming apparatus A located in the same room A as the information processing terminal 30 without any obstacle in-between is higher than that of the image forming apparatus C, although the image forming apparatus A is located at a longer distance than the image forming apparatus C. The similar situation applies to the cases when the image forming apparatus C is installed on a floor different from the floor where the information processing terminal 30 is located.

As described above, if the radio wave intensity is used as a reference for selection, the radio wave intensity is reduced by an obstacle such as a wall, floor or ceiling on the way if there is any. Thus, a higher order of priority is given to the image forming apparatus located in the same room than the image forming apparatus installed in a different room or floor, with the result that an image forming apparatus favorably located for the user is selected.

If the intensities of the radio wave emitted from image forming apparatuses 10 have been known, the intensities of the radio wave emitted from image forming apparatuses 10 can be different from one another. In this case, the intensity at the time of reception should be corrected and normalized, based on the information on the intensity of the radio wave when emitted.

The following describes the operation for selecting the power state of the transition destination requested by the power state transition request. In this case, it is assumed that each of image forming apparatuses 10 can be set in one of the power states 1 through 4, as described above.

The following methods are available to determine selection of the power state of the transition destination:

(a) The power state transition request is sent that causes transition to power state 4 independently of the power state of the image forming apparatus (the closest image forming apparatus) having been determined as a destination of the power state transition request. This arrangement keeps the image forming apparatus enabled for printing whenever required.

(b) Upon receipt of an instruction from the user (wherein the specified power state will be referred to as the “specified destination of transition”), the power state is acquired from the closest image forming apparatus. Only when the power state of the closest image forming apparatus is different from that of the specified destination of transition, power state transition request to the specified destination of transition is sent. The specified destination of transition can be checked with the user when the power is on, or the destination of transition specified in advance by the user can be stored in the memory. It is also possible to arrange such a configuration that, if the transition destination has not yet been specified by the user, a prescribed default state (for example, power state 4) will be handled as the specified destination of transition.

(c) Comparison is made between the aforementioned specified destination of transition and the power state acquired from the closest image forming apparatus. Only when the specified destination of transition is assigned with the order of priority higher than that of the power state of the closest image forming apparatus, the power state transition request to the specified destination of transition is sent.

For example, when the power state of FIG. 3 can be assumed, priority is preferably assigned in the order of power state 1<power state 2<power state 3<power state 4. This order of priority will solve the problems that may occur when the power state 4 selected by a user is suddenly changed by a new user, for example, to the power state 2 which is lower in priority than the power state 4, and the function to be used by the former user is disabled.

When a user has set the power state transition destination, the following advantages are obtained.

1. When it is desired to make an image forming apparatus receive print data, set a specified destination of transition to power state 2. This enables the adjacent image forming apparatus 10 to receive data when the information processing terminal 30 is turned on.

2. When it is desired to use only the function of saving the image data not to be printed, or of downloading a driver from the image forming apparatus 10, set the power state 3 as a specified destination of transition. This enables a desired function of the adjacent image forming apparatus 10 to be used when the information processing terminal 30 is turned on.

3. When it is desired that the device is kept in the printing possible mode at any time, set the specified destination of transition to power state 4. This enables an adjacent image forming apparatus to start printing when the information processing terminal 30 is turned on.

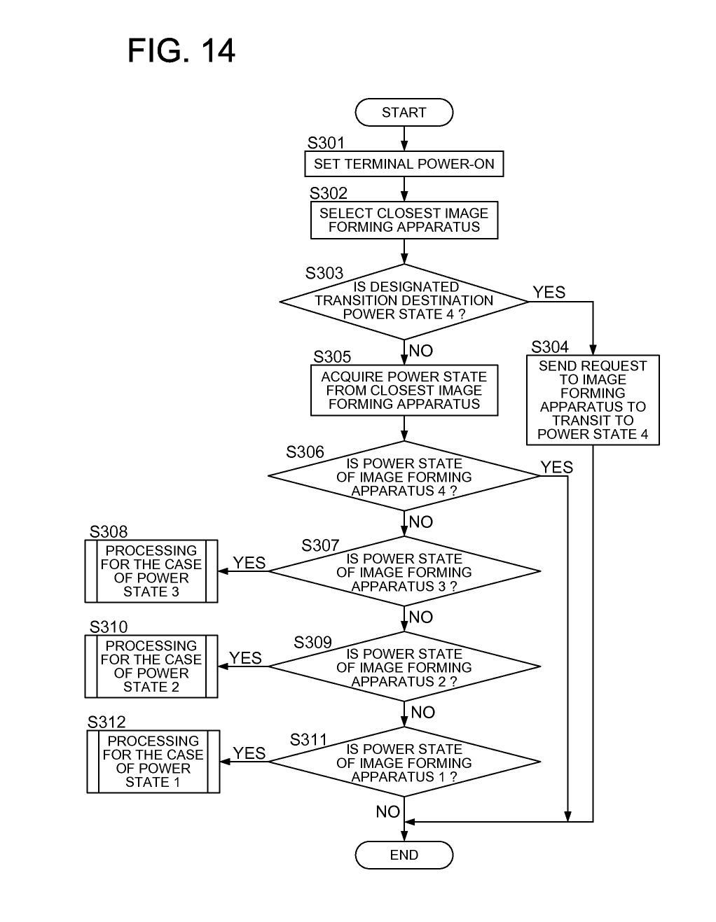

FIG. 14 shows a flow of the operation of the information processing terminal 30 when the power state transition request to the transition destination having been selected by the method based on the aforementioned procedure is sent (c). When the power is turned on (Step S301), the information processing terminal 30 selects the image forming apparatus 10 closest to the information processing terminal 30 (Step S302). The closest image forming apparatus 10 can be selected according to any of the aforementioned methods.

Then a step is taken to check if the power state specified by the user (specified destination of transition) is power state 4 or not (Step S303). If the power state 4 is selected (Step S303: Yes), a request for transition to power state 4 is sent to the image forming apparatus 10 (the closest image forming apparatus) selected in Step S302 (Step S304), whereby processing terminates.

If the specified destination of transition is not a power state 4 (Step S303: No), the information representing the power state is obtained from the closest image forming apparatus 10 selected in Step S302 (Step S305). If the power state of the closest image forming apparatus 10 is power state 4 (Step S306: Yes), there is no need of sending a power state transition request. Then processing terminates.

If the power state of the closest image forming apparatus 10 is power state 3 (Step S307: Yes), processing is performed in a manner prepared for the case when the power state is 3 (Step S308). If the power state of the closest image forming apparatus 10 is power state 2 (Step S309: Yes), processing is performed in a manner prepared for the case where the power state is 2 (Step S310). If the power state of the closest image forming apparatus 10 is power state 1 (Step S311: Yes), processing is performed in a manner prepared for the case where the power state is 1 (Step S312).

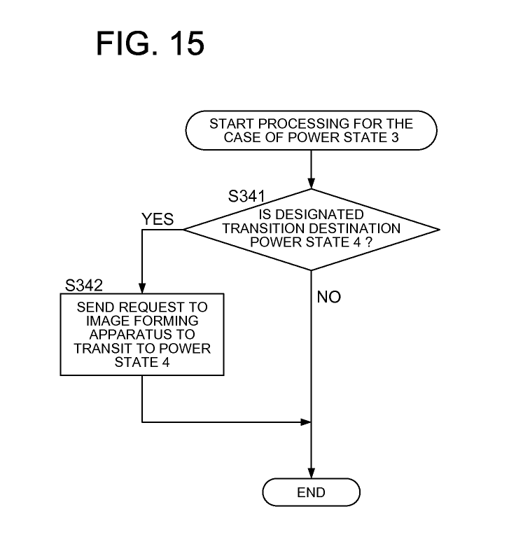

FIG. 15 shows the processing to be performed for the case where the power state of the closest image forming apparatus 10 is 3 (details of Step S308 given in FIG. 14). If the specified destination of transition is power state 4 (Step S341: Yes), a request for transition to power state 4 is sent to the closest image forming apparatus 10 (Step S342), whereby processing terminates. If the specified destination of transition is not power state 4 (Step S341: No), processing terminates without a power state transition request being sent.

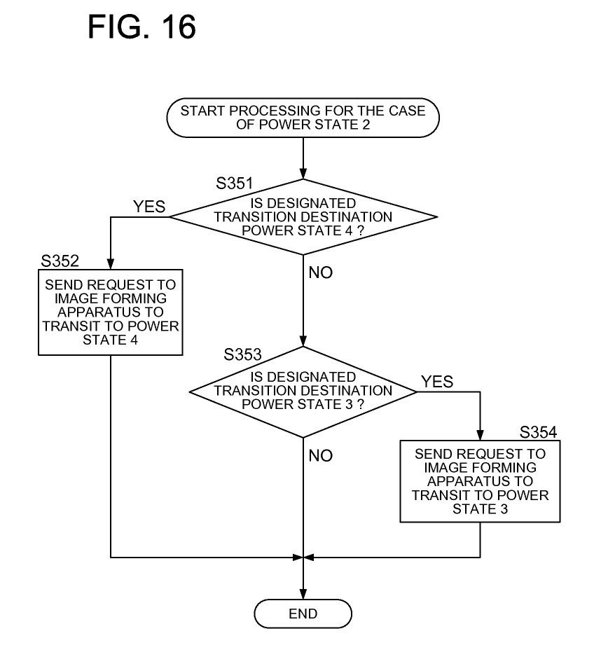

FIG. 16 shows the processing to be performed for the case where the power state of the closest image forming apparatus 10 is 2 (details of Step S310 given in FIG. 14). If the specified destination of transition is power state 4 (Step S351: Yes), a request for transition to power state 4 is sent to the closest image forming apparatus 10 (Step S352), whereby processing terminates. If the specified destination of transition is power state 3 (Step S353: Yes), a request for transition to power state 3 is sent to the closest image forming apparatus 10 (Step S354), whereby processing terminates. If the specified destination of transition is neither power state 4 nor 3 (Step S353: No), processing terminates without a power state transition request being sent.

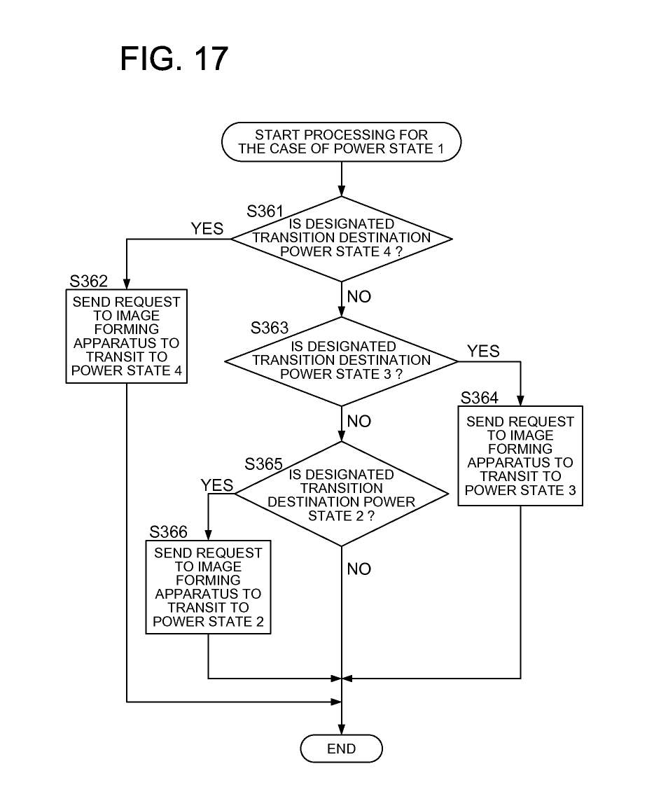

FIG. 17 shows the processing to be performed for the case where the power state of the closest image forming apparatus 10 is 1 (details of Step S312 given in FIG. 14). If the specified destination of transition is power state 4 (Step S361: Yes), a request for transition to power state 4 is sent to the closest image forming apparatus 10 (Step S362), whereby processing terminates. If the specified destination of transition is power state 3 (Step S363: Yes), a request for transition to power state 3 is sent to the closest image forming apparatus 10 (Step S364), whereby processing terminates.

If the specified destination of transition is power state 2 (Step S365: Yes), a request for transition to power state 2 is sent to the closest image forming apparatus 10 (Step S366), whereby processing terminates. If the specified destination of transition is not any of power state 4, 3 and 2 (Step S363: No), processing terminates without a power state transition request being sent.

### Second Example

In the first Example, the information processing terminal 30 selects the closest image forming apparatus 10, and power state transition request is sent to the image forming apparatus 10 from the information processing terminal 30. In the second Example, the power state transition request is sent to the image forming apparatus 10 from the management server (power state management apparatus) linked to the network 2.

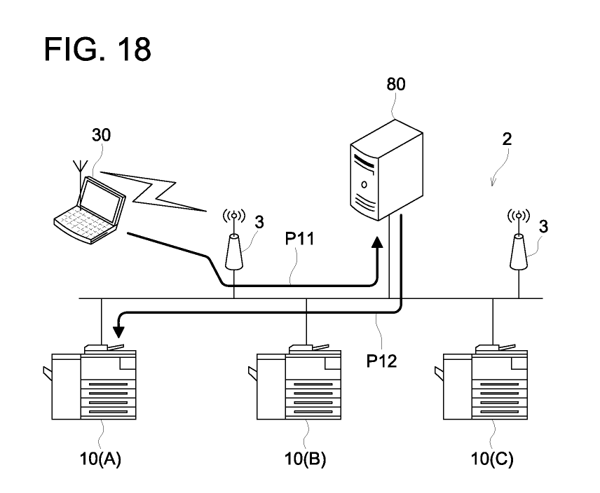

FIG. 18 shows a system configuration of the second Example. In addition to the illustrated configuration of FIG. 1, a management server 80 is connected to the wired LAN.

In the second Example, when initialization has been completed after power is turned on, the information processing terminal 30 allows the position information acquiring section 36 to detect the position of the information processing terminal 30. Then the information showing this position and information on the power state specified by the user (specified destination of transition) are sent to the management server 80 (P11). Upon receipt of the information, the management server 80 selects and determines the image forming apparatus 10 closest to the information processing terminal 30 by any one of the first through third selection determining methods shown in the first Example (except for the fourth selection determining method when radio wave intensity is used) and sends a power state transition request to the selected image forming apparatus 10 (P12). The management server 80 is required to use any one of the methods shown in the first Example as a method for selecting the power state of the transition destination required by the power state transition request.

The management server 80 stores the information on the position of each image forming apparatus 10 in advance. It also stores the database when the area showing the scope of a room and others is registered. The management server 80 makes comparison between the information on the position of the information processing terminal 30 received from the information processing terminal 30 and the information on the position of the image forming apparatus 10 stored in advance, and refers to the database when the areas are registered, whereby the image forming apparatus (the closest image forming apparatus) as a destination of sending the power state transition request is selected. Further, the power state information is obtained from the closest image forming apparatus, and is compared with the specified destination of transition set by the user of the information processing terminal 30. Then a step is taken to determine whether or not the required power state and power state transition request should be sent to the closest image forming apparatus. If the decision is affirmative, a request for transition to the determined power state is sent.

### Third Example

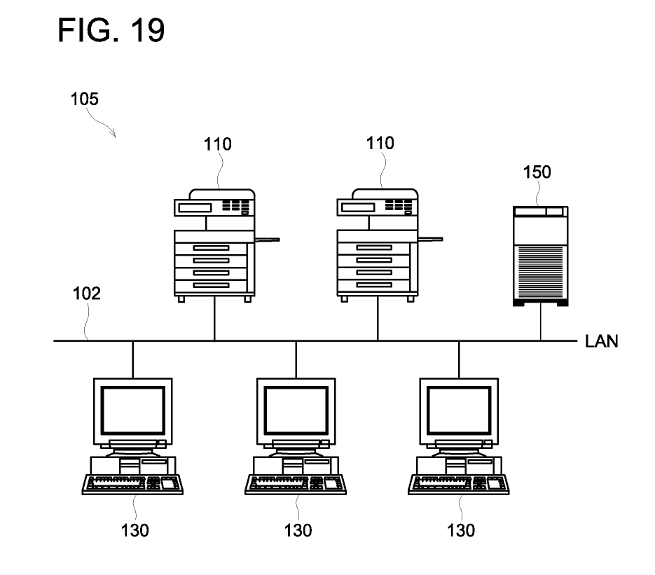

FIG. 19 shows the configuration of the system 105 in the third Example of the present invention. This system 105 consists of a network 102 such as a LAN (Local Area Network) installed in an office or the like, which is linked with plural image forming apparatuses 110, plural terminal devices 130 and a server device 150.

The terminal device 130 includes a personal computer (PC) and others, and has a function of sending a job to the image forming apparatus 110. The image forming apparatus 110 has a function of processing the job received from the terminal device 130. The server device 150 also has a function of serving as a power state management apparatus (management server) for managing the power state of the image forming apparatus 110. To put it in more detail, the server device 150 acquires the information on the position and number of the terminal devices 130 in the started-up state and the information on the position of each image forming apparatus 110. Based on these pieces of information, the server device 150 selects the image forming apparatus to be set to the power-on state out of plural image forming apparatuses 110, and sets the relevant image forming apparatus 110 to the power-on state. At the same time, the server device 150 sets other image forming apparatuses 110 to the power-off state.

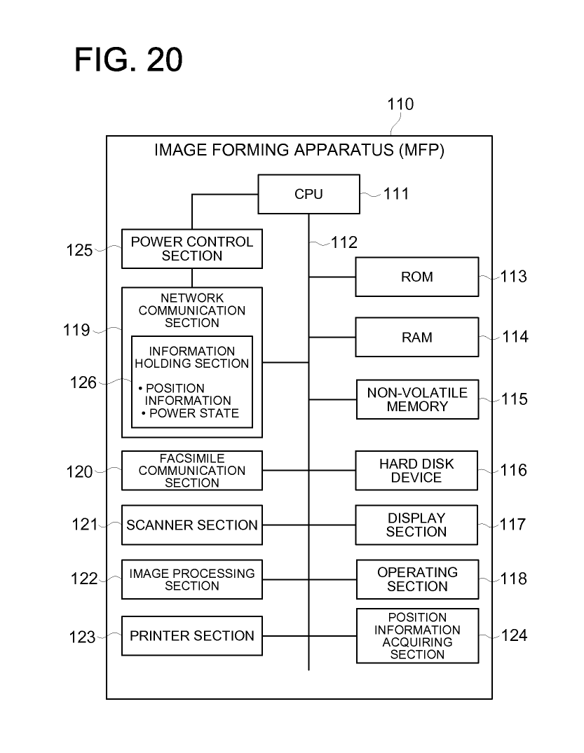

FIG. 20 shows the general configuration of the image forming apparatus 110. The image forming apparatus 110 is a so-called multi-functional peripheral (MFP) provided with a copying function of optically reading a document image and printing the copied image onto a recording sheet, a scanning function of storing the read document image data as a file, and sending it to the terminal device 130, a printer function of forming on a recording sheet an image based on the printing data received from the terminal device 130 and an image based on the image data stored in the image forming apparatus 110, and a facsimile function. The image forming apparatus 110 can be a device having a function of receiving a job from the terminal device 130. For example, it can be a printer having only the printing function or a facsimile device having a function of transmitting the image data received from the terminal device 130 to an external device.

The image forming apparatus 110 consists of the CPU (Central Processing Unit) 111 for controlling the operation of the image forming apparatus 110, with the CPU 111 connected with a ROM (Read Only Memory) 113, RAM (Random Access Memory) 114, nonvolatile memory 115, hard disk device 116, display section 117, operation section 118, network communication section 119, facsimile communication section 120, scanner section 121, image processing section 122, printer section 123, and position information acquiring section 124 via the bus 112. Further, the image forming apparatus 110 has a power control section 125 to control power (power on/off control) of the image forming apparatus 110 and to control power supplied to various sections.

The CPU 111 controls the operation of the image forming apparatus 110 in conformity to the program stored in the ROM 113. The ROM 113 stores various programs to be executed by the CPU 111 and various fixed data. The RAM 114 is used as a work memory to store data temporarily when the program is executed by the CPU 111, and as an image memory for storing the image data temporarily. The nonvolatile memory 115 is a rewritable memory when the stored data is kept undeleted when the power is turned off. The nonvolatile memory 115 stores the information inherent to the device (e.g., name and IP (Internet Protocol) address) and various forms of setting information. The hard disk device 116 stores various forms of data to be saved, as well as various forms of image data having been inputted.

The display section 117 is made up of a liquid crystal display and others, and displays various screens such as an initial screen, operation screen and setting screen. The operation section 118 includes various buttons such as the start button, stop button and ten-keys, and a touch panel provided on the liquid crystal display and used to detect the position of the coordinates when the panel is pressed. The operation section 118 receives various operations for the image forming apparatus 110, performed by the user.

The scanner section 121 optically reads the document image and acquires the image data. The scanner section 121 has, for example, a light source for emitting light to the document, a line image sensor for receiving reflected light and reading one line of the document across the width, a moving device for sequentially moving the line-by-line reading positions across the length of the document, and an optical system including a lens and mirror by which the light reflected from the document is led to the line image sensor and is formed into an image. The scanner section 121 also includes a conversion section for converting the analog image signal outputted from the line image sensor, into the digital image data.

The image processing section 122 allows image data to be subjected to image processing such as image correction, rotation, enlargement/reduction, and compression/decompression.

The printer section 123 forms an image based on the image data according to the electrophotographic process and outputs the image on a recording sheet. The printer section 123 is a so-called laser printer including, for example, a recording sheet conveying device, photoreceptor drum, charging device, LD (Laser Diode) to be turned on or off in response to the inputted image data, scanning unit for scanning the laser light emitted from the LD, on the photoreceptor drum, development device, transfer and separation device, cleaning device and fixing device. It is possible to use a printer of other types such as an LED printer when the light of the LED (Light Emitting Diode), instead of laser light, is applied to the photoreceptor drum.

The position information acquiring section 124 acquires the position information indicating the installation area of the image forming apparatus 110. In this Example, a GPS (Global Positioning System) is used to get the position information.

It is also possible to adopt such a structure that the position information of the image forming apparatus 110 is detected by another device having a GPS function (GPS position detecting device), without the image forming apparatus 110 being provided with a position information acquiring section 124, and is inputted into the image forming apparatus 110 to be stored. The image forming apparatus 110 is hardly moved from the installation site subsequent to its installation. Accordingly, it is possible to make such arrangements that the position information is detected by the GPS position detecting device and is inputted into the image forming apparatus 110 to be stored therein. For example, a cellular mobile telephone with a GPS function is employed to get the information on the position when the image forming apparatus 110 is installed. The position information having been detected can be stored, for example, in the nonvolatile memory 115 of the image forming apparatus 110.

The facsimile communication section 120 communicates with an external device provided with a facsimile function through the public line to exchange image data. The network communication section 119 communicates with the terminal device 130, server device 150, and other image forming apparatuses 110 via the network 102, and exchanges various forms of data.

The network communication section 119 operates independently to receive and analyze data, and to send the required reply to the transmitter of the data, even if the image forming apparatus 110 has been shifted to the power-off state (soft-off state) and the operation of the CPU 111 has been suspended. In this case, the network communication section 119 is provided with an information holding section 126 for storing the position information and the information on the current power state of the image forming apparatus 110. When the network communication section 119 has received an acquisition request of the position information and power state from the server device 150, the related information is read from the information holding section 126, and a reply is sent back.

The power control section 125 converts the power from the commercial power source into the appropriate voltage and supplies power to various portions of the image forming apparatus 110. Further, according to the instruction from the CPU 111, the power control section 125 is capable of determining, for each destination of supply, whether power should be supplied or suspended.

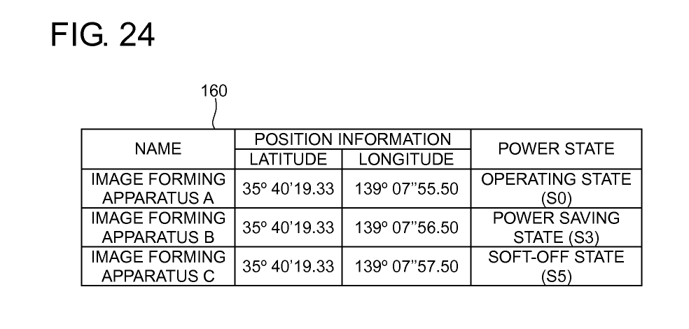

The image forming apparatus 110 has an operating state (S0), power saving state (S3), soft-off state (S5) as power states (FIG. 24), and is capable of transition to one of these power states.

In the soft-off state, power is turned off by software. In this case, power is supplied to the network communication section 119 alone. Power supply to other portions including the CPU 111 is suspended to minimize power consumption. In the soft-off state, the network communication section 119 is capable of receiving, analyzing and transmitting data, and is capable of responding to the acquisition request of position information or power state from the server device 150 on the network 102.

In the operating state, power is supplied to all the portions of the image forming apparatus 110. All functions can be used although power consumption is not suppressed.

In the power saving state, power is supplied to prescribed portions including the network communication section 119, CPU 111, ROM 113 and RAM 114, without power supplied to other portions. Power consumption is reduced below that in the operating state. For example, supply of power to the portions related to the functions (such as copying, scanning, printer, image processing and display functions) is suspended while keeping the network communication function performed by the network communication section 119 (including the function of detecting the reception of a job from the terminal device 130) and the function of detecting the operation made to the operation section 118 and facsimile reception from an external device.

The image forming apparatus 110 in the operating state is automatically shifted to the power saving state if the standby mode continues over a prescribed period of time in such a way that execution of a job using the scanner section 121 or printer section 123, or the operation of the operation section 118 is not performed. The image forming apparatus 110 in the power saving state is automatically shifted to the operating state upon detection of a job from the terminal device 130, operation made to the operation section 118, or detection of facsimile from the external device. In the operating state and power saving state, power is supplied to the CPU 111. In the case of automatic transition between these states, the CPU 111 sends an instruction to the power control section 125 to shift the state of power supply for various portions.

In the following description, the operating state and soft-off state will be described in terms of power-on state and power-off state, respectively. It should be noted that the power saving state is included in the power-on state in this Example.

Upon receipt of a power state transition request (power-on request/power-off request) from the server device 150, the image forming apparatus 110 shifts the power state. To put it in more detail, when the power-on request has been received, the server device 150 shifts the power-off state (soft-off state) to the power-on state (operating state). When the power-off request has been received, the server device 150 shifts the power-on state to the power-off state.

In the power-off state, upon receipt of a power-on request from the server device 150, the network communication section 119 sends the power-on signal (power-on state transition signal) to the power control section 125 and CPU 111. Having received this signal, the power control section 125 supplies power to the CPU 111, ROM 113, RAM 114 and others. The CPU 111 starts operation using the power supplied from the power control section 125, and outputs an instruction to the power control section 125 to supply power to various portions so that the image forming apparatus 110 is shifted from the power-off state to the power-on state.

In the power-on state, having received a power-off request from the server device 150, the network communication section 119 sends the power-off signal (power-off state transition signal) to the CPU 111. Upon receipt of this signal, the CPU 111 sends an instruction to the power control section 125 to suspend supply of power to various portions, and to shift the image forming apparatus 110 from the power-on state to the power-off state.

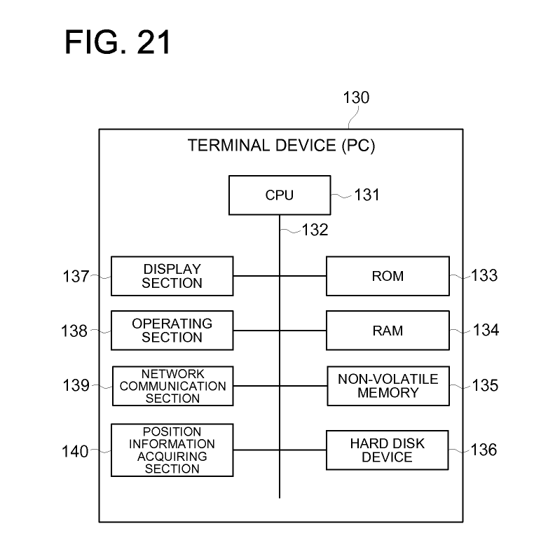

FIG. 21 shows the general configuration of the terminal device 130. The terminal device 130 has a function of sending a job such as a scanning job and printing job to the image forming apparatus 110 and requesting execution of the job. The terminal device 130 includes the personal computer (PC) incorporating the OS program, driver program of the image forming apparatus 110, and application program for creating and editing of the document or image.

The terminal device 130 includes the ROM 133, RAM 134, nonvolatile memory 135, hard disk device 136, display section 137, operation section 138, network communication section 139, position information acquiring section 140 which are connected to the CPU 131 via the bus 132.

According to the program stored in the ROM 133, the CPU 131 controls the operation of the terminal device 130, and executes various forms of processing according to the program incorporated in the hard disk device 136. The ROM 133 stores the boot-up program and fixed data. The RAM 134 stores the program read out of the hard disk device 136. The RAM 134 is also used as a work memory for temporary storage of various data when the CPU 131 executes a program.

The nonvolatile memory 135 is a rewritable memory which retains the stored content even when power is turned off, and stores the system information (device ID (Identification), IP address and others) of the terminal device 130, user information, various forms of setting information. The hard disk device 136 is a large-capacity nonvolatile storage device, and stores the OS program, driver program of the image forming apparatus 110, various forms of application programs and file data.

The display section 137 includes a display device such as a liquid crystal display. The operation section 138 includes such an operation input device as the keyboard or mouse.

The position information acquiring section 140 acquires the position information indicating the installation position of the terminal device 130. In this case, the GPS is used to get the position information.

When the terminal device 130 is configured by the desk top PC, the terminal device is hardly removed from the installation site after having been installed. Similarly to the case of the image forming apparatus 110, it is also possible to make such arrangements that, with the terminal device 130 being not provided with a position information acquiring section 140, another device having a GPS function (GPS position detecting device) is used to detect the position information of the terminal device 130, which is inputted into the terminal device 130 and stored in the nonvolatile memory 135 or the like.

The network communication section 139 communicates with the image forming apparatus 110, server device 150 and other terminal devices 130 via the network 102 to exchange various data. When the terminal device 130 is turned on (i.e., when starting up), the power-on notice and position information are sent to the server device 150. When the terminal device 130 is turned off (i.e., is stopped), the power-off notice is sent to the server device 150. When power-on notice or power-off notice is sent, the device ID, IP address are also sent.

The started-up state of the terminal device 130 includes: (1) the state where the terminal device 130 has been turned on; (2) the state where the driver program has started to perform the function of sending a job to the image forming apparatus 110; and (3) the state where the application program using the aforementioned driver program has started. Any of these states can be defined as the started-up state by appropriate selection. The power saving state can be included in the power-on state, or the power-on state can be defined purely as a regular state without the power saving state being included.

The terminal device 130 in the started-up state can be the terminal device 130 in the state where the device has been started up after the power is turned on, or the terminal device 130 placed in the regular state in the above state, or the terminal device 130 in a state where the driver program has been started in that regular state. If the terminal device 130 is placed in the regular state, when the terminal device 130 has transitioned to the regular state, the terminal device 130 sends the notice (the regular state transition notice) to the server device 150. This procedure allows the server device 150 to be notified that the terminal device is in the regular state. In the case of the terminal device 130 where the driver program has been started, when the driver program has started, the terminal device 130 sends the notice (driver program startup notice) to the server device 150. This allows the server device 150 to be notified that the terminal device 130 has started the driver program.

The following description assumes that the terminal device 130 in the started-up state is the terminal device 130 in the state where the device has been started up after the power is turned on.

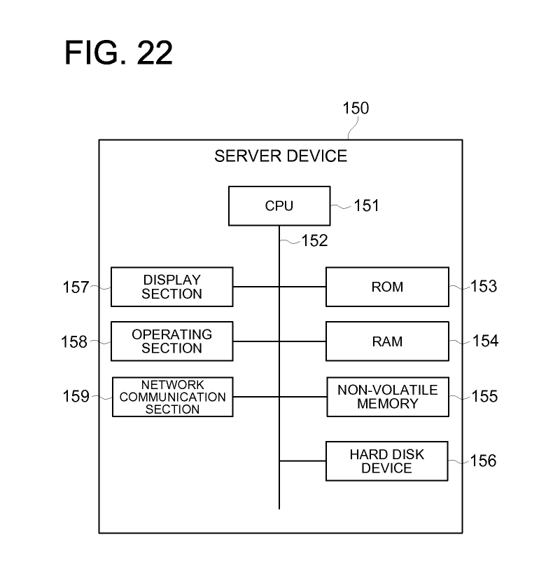

FIG. 22 shows the general configuration of the server device 150. The server device 150 has a function of providing power control in such a way that the power state of the image forming apparatus 110 is changed to the power-on state or power-off state. The server device 150 includes the general-purpose computer containing the OS program and the power management program for controlling the power state of the image forming apparatus 110.

The server device 150 includes the ROM 153, RAM 154, nonvolatile memory 155, hard disk device 156, display section 157, operation section 158 and network communication section 159 linked to the CPU 51 via the bus 152.

The CPU 151 controls the operation of the server device 150 and executes power control of the image forming apparatus 110 according to the program stored in the ROM 153 or hard disk device 156. The ROM 153 stores the boot-up program and fixed data. The RAM 154 contains the program read out of the hard disk device 156. The RAM 154 is used as a work memory for temporarily storing various forms of data when the CPU 151 executes a program.

The nonvolatile memory 155 is a rewritable memory which retains the stored content even when power is turned off, and stores the system information (name, IP address and others) of the server device 150, and various forms of setting information. The hard disk device 136 is a large-capacity nonvolatile storage device, and incorporates a database that stores the OS program, power management program, various information used for power control of the image forming apparatus 110.

The display section 157 includes a display device such as a liquid crystal display. The operation section 158 includes an operation input device such as a keyboard and mouse. The network communication section 159 communicates with the image forming apparatus 110, terminal device 130 and other external devices to exchange various data through the network 102.

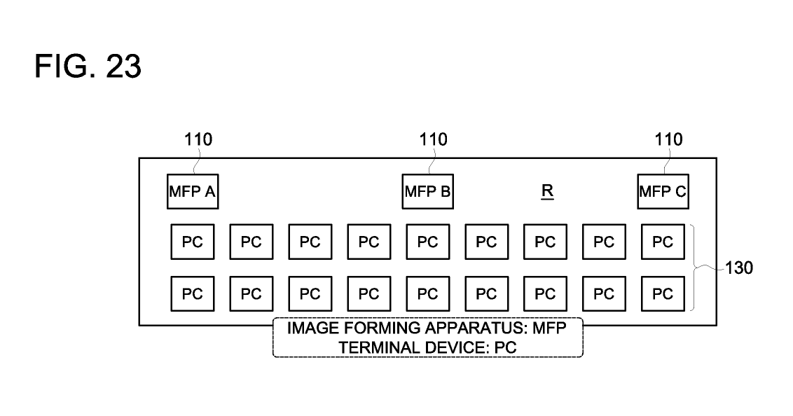

FIG. 23 shows an example of the layout of the image forming apparatus 110 and terminal device 130 located inside the management area R by the server device 150. In the drawing, the image forming apparatus is represented as “MFP”, and the terminal device is represented as “PC”. In the similar layout drawing representing the management area R in the following description, the same representations will be used to denote the image forming apparatus and terminal device.

The management area R accommodates the image forming apparatus 110 whose power state is managed by the server device 150, and the terminal device 130 that sends a job to the image forming apparatus 110. For example, the management area R is a room or office where an image forming apparatus 110 and terminal device 130 are installed. The management area can be an area including plural rooms. The following description assumes the management area R to be a single room.

Three image forming apparatuses 110 (image forming apparatuses A, B and C) and a great number of (eighteen in the example of FIG. 23) terminal devices 130 are installed in the management area R in this Example. The image forming apparatuses 110 are arranged in a row apart from one another by a prescribed distance. The terminal devices 130 are arranged in two rows approximately in parallel with the row of the image forming apparatuses 110, and are close to one another.

The server device 150 (not illustrated in FIG. 23) monitors the power on/off states of each of the terminal devices 130 in the management area R. The server device 150 provides control in such a way that the number of the image forming apparatuses 110 which is located so as to ensure easy use from the terminal device 130 in the started-up state and the number of which is optimized based on the number of the terminal devices 130 in the started-up state are changed to the power-on state, while other image forming apparatuses 110 are set to the power-off state. This power control includes the control of turning on the image forming apparatus 110 in the power-off state which has been determined to be turned on, and the control of turning off the image forming apparatus 110 in the power-on state which has been determined to be turned off. As described above, the image forming apparatus 110 to be turned on is determined (selected) based on the information on the position and number of the terminal devices 130 in the started-up state and information on the position of the image forming apparatuses 110. A decision is made to turn off the mage forming apparatuses 110 other than the image forming apparatuses 110 having been determined to be turned on.

FIG. 24 shows the database 160 provided to ensure that the device information on the image forming apparatus 110 is retained by the server device 150. This database 160 is stored in the hard disk device 156 of the server device 150 or the nonvolatile memory 155.

The database 160 contains the information on the names, positions and power states of the image forming apparatuses 110 registered in an associated form. This drawing shows the case wherein the three image forming apparatuses A, B and C of FIG. 23 are registered in the database 160. The position information is made up of a latitude and longitude. The power state includes the aforementioned operating state (S0), power saving state (S3) and soft-off state (S5).

The database 160 is updated when the device information of a new image forming apparatus 110 is registered, when the device information of the registered image forming apparatus 110 is deleted, and when the power state of the registered image forming apparatus 110 is changed.

It is also possible to adopt such a structure that the name and position information of the image forming apparatus 110 are acquired and registered actively by the server device 150 from the image forming apparatus 110, or passively from the image forming apparatus 110.

When the name and position information of the image forming apparatus 110 are acquired and registered actively, for example, the server device 150 detects the image forming apparatuses 110 inside the management area R linked to the network 102 on a periodic basis, acquires the names and positions information from the detected image forming apparatuses 110 and registers such information in the database 160. Then the name and position information (device information) of the image forming apparatuses 110 not detected any more are deleted from the database 160, whereby the database 160 is updated.

To put it in more detail, for example, the server device 150 detects the image forming apparatuses 110 inside the management area R linked to the network 102 on a periodic basis, and the position information notice request is sent to the newly detected image forming apparatus 110. The image forming apparatus 110 having received the position information notice request sends the name and position information (latitude and longitude) of the image forming apparatus 110 to the server device 150. The server device 150 organizes the name and position information having received from the image forming apparatus 110 in an associated form, and registers it in the database 160.

When an image forming apparatus 110 is moved out of the management area R, the image forming apparatus 110 is disconnected from the network 102. The server device 150 ensures that the name and position information (device information) of the image forming apparatuses 110 not detected any more on the network 102 among the image forming apparatuses 110 registered in the database 160 are deleted from the database 160.

When the image forming apparatus 110 registered in the database 160 is moved to another position inside the management area R, the image forming apparatus 110 is once disconnected from the network 102, and is moved to another place. Then the image forming apparatus 110 is again linked to the network 102. The position information indicating the new installation site is acquired by the position information acquiring section 124. The server device 150 deletes, from the database 160, the device information of the image forming apparatus 110 not detected any more on the network 102 due to temporary disconnection from the network 102 among the image forming apparatuses 110 registered in the database 160. After that, when this image forming apparatus 110 having been moved to a new site is detected on the network 102 is detected on the network 102, the name and position information (position information representing the new installation site) are received from this image forming apparatus 110, and are registered in the database 160 after having been organized in an associated form.

When the name and position information of the image forming apparatus 110 are acquired passively, for example, the server device 150 receives the name and position information sent from the image forming apparatus 110 inside the management area R linked to the network 102 and registers them in the database 160. When the image forming apparatus 110 is disconnected from the network 102, the server device 150 receives the notice to that effect (network disconnection notice) and deletes the name and position information (device information) of the image forming apparatus 110 from the database 160, whereby the database 160 is updated.

To put it in more detail, for example, the image forming apparatus 110 is installed in the management area R and is connected to the network 102. At the same time, when the position information indicating the installation area thereof is acquired by the position information acquiring section 124, the name and position information of the image forming apparatus 110 is sent to the server device 150. When the server device 150 has received the name and position information from the image forming apparatus 110, they are registered into the database 160 in an associated form.

When the image forming apparatus 110 is moved out of the management area R, the image forming apparatus 110 sends the network disconnection notice and the name of image forming apparatus 110 to the server device 150 when disconnected from the network 102. Upon receipt of the name of the image forming apparatus 110 together with the network disconnection notice, the server device 150 deletes the name and position information (device information) of the image forming apparatus 110 from the database 160.

When the image forming apparatus 110 registered in the database 160 is moved to another site within the management area R, the aforementioned network disconnection notice is sent to the server device 150 when the image forming apparatus 110 is disconnected from the network 102. This procedure ensures the name and position information (device information) of the image forming apparatus 110 to be once deleted from the database 160. The image forming apparatus 110 is moved to another site within the management area R and is connected to the network 102, and the name of the image forming apparatus 110 and the position information representing the new installation site are sent to the server device 150. This procedure allows the name and position information of the image forming apparatus 110 to be registered into the database 160.

Instead of using the structure where the server device 150 receives the network disconnection notice from the image forming apparatus 110 and the device information of the image forming apparatus 110 is deleted from the database 160, it is also possible to adopt such a structure that the server device 150 detects the image forming apparatus 110 inside the management area R connected to the network 102 on a periodic basis, and the device information of the image forming apparatus 110 not detected any more on the network 102 is deleted from the database 160.

It is also possible to make such arrangements that the server device 150 acquires actively and registers the power state of the image forming apparatus 110 from the image forming apparatus 110, or the server device 150 acquires passively and registers the power state from the image forming apparatus 110.

When the power state of the image forming apparatus 110 is acquired and registered actively, for example, the server device 150 detects the image forming apparatuses 110 inside the management area R linked to the network 102 on a periodic basis, and the power state notice request is sent to the detected image forming apparatus 110. The image forming apparatus 110 having received the power state notice request sends the own name and information on the power state to the server device 150. The server device 150 registers the power state received from the image forming apparatus 110 by associating the power state with a name stored in the database corresponding to the name received from the image forming apparatus 110.

When the power state of the image forming apparatus 110 is acquired and registered passively, the image forming apparatus 110 sends its name and the information denoting the power state subsequent to the shift thereof to the server device 150 at the time of shifting the power state. The server device 150 registers the power state received from the image forming apparatus 110 by associating it with a name stored in the database 160 corresponding to the name received from the image forming apparatus 110.

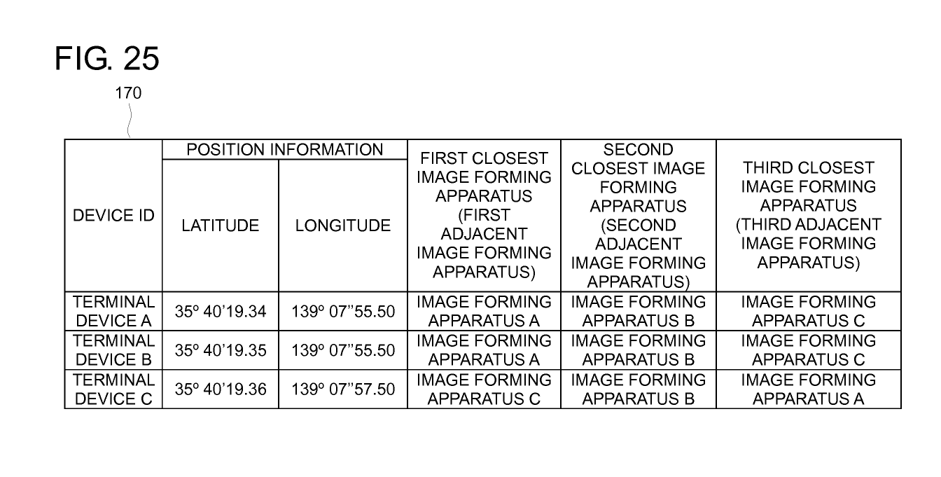

FIG. 25 shows the database 170 provided in the server device 150 to store the device information of the terminal device 130 in the started-up state. This database 170 is incorporated in the hard disk device 156 or nonvolatile memory 155 of the server device 150.

The device ID of the terminal device 130 in the started-up state, position information, the name of the image forming apparatus 110 first closest to the terminal device 130, the name of the second closest image forming apparatus 110, and the name of the third closest image forming apparatus 110 are registered in the database 170 in the associated form. FIG. 25 shows an example when three terminal devices A, B and C are registered in the database 170. The first, second and third closest image forming apparatuses 110 correspond to the image forming apparatuses A, B and C registered in the database 160 of FIG. 24.

The position information is made up of a latitude and longitude. The first, second and third closest image forming apparatuses 110 calculate the distance between the terminal device 130 and each of the image forming apparatuses 110, using the position information of the terminal device 130 and the position information of each image forming apparatus 110 registered in the database 160, and make a decision based on the result of this calculation. To be more specific, the image forming apparatus 110 closest to the terminal device 130 is determined to be the closest image forming apparatus 110, the image forming apparatus 110 closest to the terminal device 130 next is determined to be the second closest image forming apparatus 110, and the image forming apparatus 110 closest to the terminal device 130 further next is determined to be the third closest image forming apparatus 110.

The closest image forming apparatus is also called “the first adjacent image forming apparatus”, the second closest image forming apparatus is also called “the second adjacent image forming apparatus”, and the third closest image forming apparatus is also called “the third adjacent image forming apparatus”.

The database 170 is updated when the device information of the terminal device 130 that has been newly started up is registered, and when the already registered terminal device 130 in the started-up state is suspended and the device information of that terminal device 130 is deleted.

When the power is turned on, the terminal device 130 sends the power-on notice, device ID and position information to the server device 150. Having received the power-on notice as well as the device ID and position information from the terminal device 130, the server device 150 associates the device ID and position information and registers them in the database 170. In addition, the server device 150 determines the first, second and third closest image forming apparatuses 110 from the terminal device 130, associates the names of these image forming apparatuses 110 with the device ID of the terminal device 130, and registers them in the database 170.

When power is turned off, the terminal device 130 sends the power-off notice and device ID to the server device 150. Having received the power-off notice as well as the device ID from the terminal device 130, the server device 150 deletes the device information of the terminal device 130 corresponding to the device ID from the database 170.

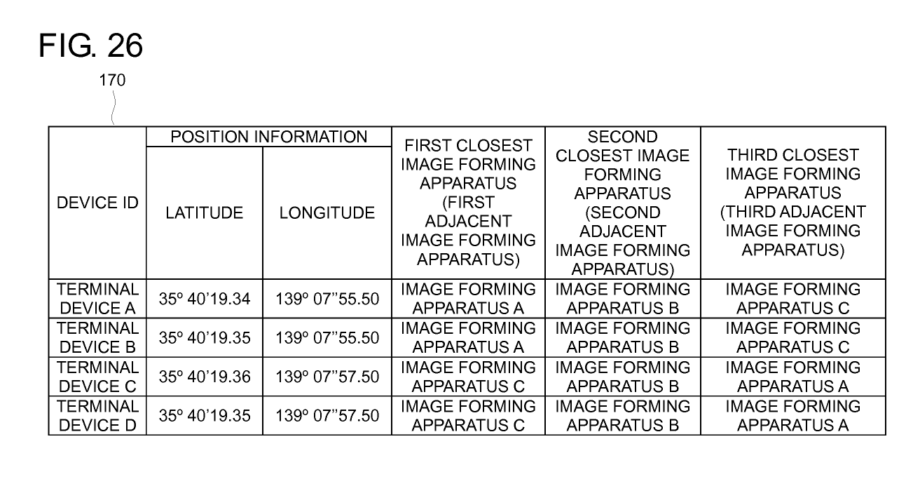

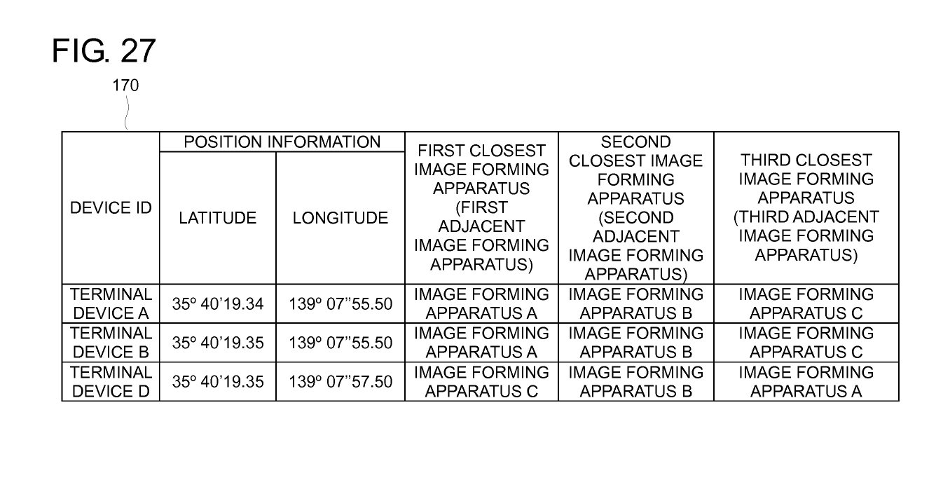

FIG. 26 shows the case when the information of the terminal device D that has been in the started-up state after being turned on newly is additionally registered into the database 170 of FIG. 25, whereby the database 170 has been updated. FIG. 27 shows the case when the information of the terminal device C having been suspended after being turned off newly is deleted from the database 170 of FIG. 26, whereby the database 170 has been updated.

The following describes the operation of the image forming apparatus 110:

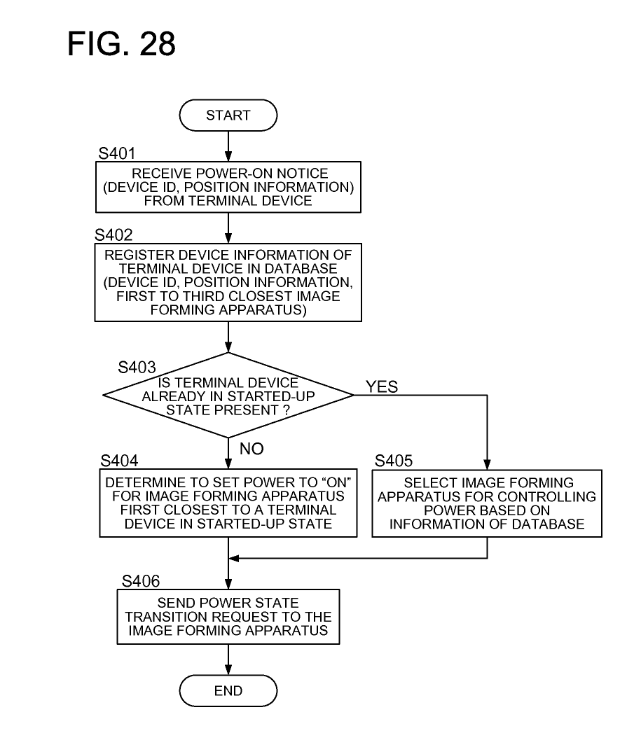

FIG. 28 is a flow chart showing the operation when the server device 150 receives a power-on notice from the terminal device 130.

Upon receipt of the power-on notice, device ID and position information from the terminal device 130 (Step S401), the CPU 151 registers the device information on the terminal device 130 in the database 170 (Step S402). To put it in more detail, the CPU 151 associates the device ID and position information received from the terminal device 130 with each other and registers them in the database 170. Based on the position information of the terminal device 130 and the position information of the image forming apparatus 110 registered in the database 160, the CPU 151 determines the first closest image forming apparatus 110, the second closest image forming apparatus 110, and third closest image forming apparatus 110 with reference to the terminal device 130 and registers them in the database 170.

If there is no other terminal device 130 already in the started-up state (Step S403: No), the image forming apparatus 110 first closest to one terminal device 130 currently in the started-up state is specified by reference to the database 160, and that image forming apparatus 110 is determined to be set to the power-on state (Step S404). Then a power state transition request is sent to this image forming apparatus 110 (Step S406/End). The details of the method of determination given in Step S404 will be described later.

In this case, before one terminal device 130 is turned on, all the image forming apparatuses 110 are in the power-off state without any terminal device 130 in the started-up state. When one terminal device 130 has been turned on under this condition, the server device 150 sends a power-on request to the image forming apparatus 110 first closest to this terminal device 130. Upon receipt of the power-on request from the server device 150, the image forming apparatus 110 turns on the power so that the power-off state is changed to the power-on state.

If there is any other terminal device 130 already in the started-up state (Step S403: Yes), a step is taken to determine the image forming apparatus 110 which is subjected to power control (power on/off control) based on the information registered in the databases 160 and 170 (Step S405), and the power state transition request is sent to this image forming apparatus 110 (Step S406/End). The method of determination in Step S405 and detailed contents of the transmission in Step S406 will be described later.

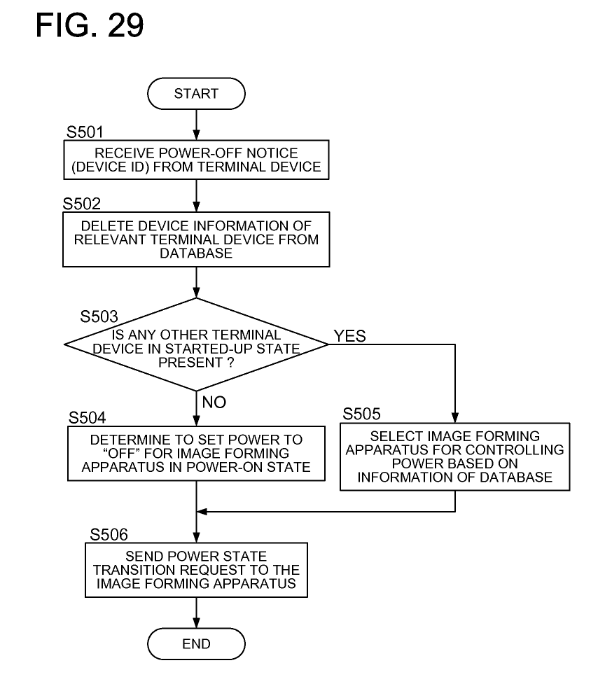

FIG. 29 shows the flow of operation when a power-off notice has been received by the server device 150 from the terminal device 130.

Upon receipt of the power-off notice and device ID from the terminal device 130 (Step S501), the CPU 151 deletes the device information of the terminal device 130 corresponding to the device ID from the database 170 (Step S502).

If there is no other terminal device 130 in the started-up state (Step S503: No), the image forming apparatus 110 currently in the power-on state is specified by reference to the database 170, and this image forming apparatus 110 is determined to be set to the power-off state (Step S504). A power state transition request is sent to this image forming apparatus 110 (Step S506/End).

In this case, before one terminal device 130 is turned off, only one terminal device 130 is in the started-up state and only the image forming apparatus 110 first closest to the one terminal device 130 is in the power-on state. If the last one terminal device 130 is suspended under this condition, the server device 150 sends power-off request to the image forming apparatus 110 first closest to this terminal device 130. Upon receipt of the power-off request from the server device 150, the image forming apparatus 110 turns power off, whereby the power-on state is changed to the power-off state. To be more specific, all the image forming apparatuses 110 in the management area R are set to the power-off state.

If there is another terminal device 130 in the started-up state (Step S503: Yes), a step is taken to determine the image forming apparatus 110 which is subjected to power control (power on/off control) based on the information registered in the databases 160 and 170 (Step S505), and the power state transition request is sent to this image forming apparatus 110 (Step S506/End). The method of determination in Step S505 and detailed contents of the transmission in Step S506 will be described later.

The following describes the method for determining the image forming apparatus 110 which is subjected to power control. In this Example, the following six methods are used to determine which the image forming apparatus 110 is to be set to the power-on state. Other image forming apparatuses 110 are set to the power-off state.

Determination method 1 . . . When there is only one terminal device in the started-up state, the image forming apparatus first closest to this terminal device is determined to be set to the power-on state (Step S404 of FIG. 28).

Determination method 2 . . . When one image forming apparatus is first closest to each of all the terminal devices in the started-up state and the number of these terminal devices in the started-up state is smaller than a prescribed number, then this image forming apparatus is determined to be set to the power-on state.

Determination method 3 . . . When one image forming apparatus is first closest to each of all the terminal devices in the started-up state, and the number of these terminal devices in the started-up state is equal to or greater than a prescribed number, this image forming apparatus and image forming apparatus the second closest to these terminal device are determined to be set to the power-on state.

Determination method 4 . . . When one image forming apparatus is not first closest to each of all the terminal devices in the started-up state, and there is an image forming apparatus intermediate between these terminal devices in the started-up state, this intermediate image forming apparatus is determined to be set to the power-on state.

Determination method 5 . . . When one image forming apparatus is not first closest to each of all the terminal devices in the started-up state, and there is no image forming apparatus intermediate between these terminal devices in the started-up state, the image forming apparatus already in the power-on state continues to be used.

Determination method 6 . . . The image forming apparatus not first closest to the terminal device in the started-up state and located more than a prescribed distance away is excluded from the candidates of the image forming apparatus to be set to the power-on state related to this terminal device.

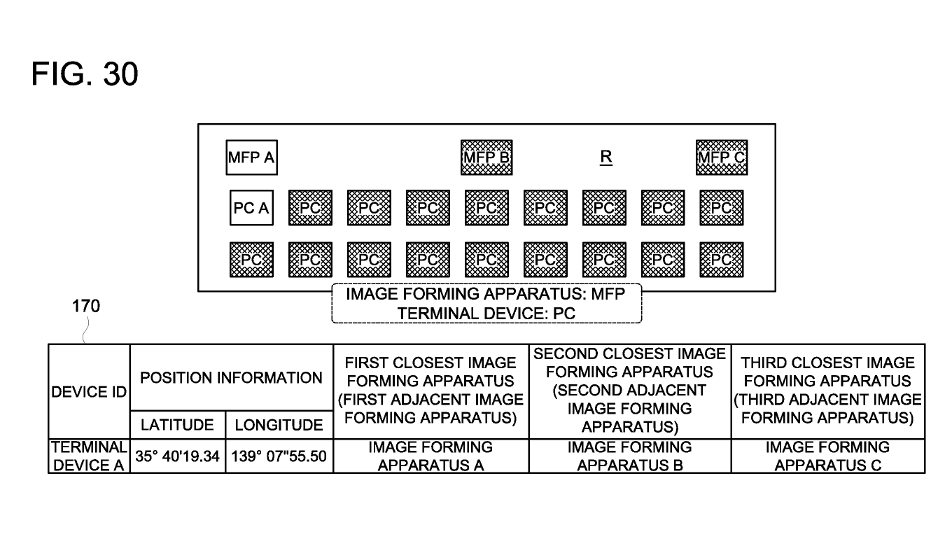

The following describes the specific examples of the Determination methods 1 through 6 with reference to FIG. 30 through FIG. 38. In FIG. 30 through FIG. 38, the terminal device 130 (PC) in the started-up (power-on) state within the management area R is shown in white-out, and the terminal device 130 in the stopped (power-off) state is shown by hatching. The mage forming apparatus 110 (MFP) to be set to the power-on state is shown in white-out, and the image forming apparatus 110 to be set to the power-off state is shown by hatching. The database 170 in which the position information of the terminal device 130 in the started-up state and the first through third closest image forming apparatuses 110 have been registered are also shown.

(Determination Method 1)

FIG. 30 shows an example of the image forming apparatus 110 to be set to the power-on state when there is one terminal device 130 in the started-up state in the management area R. If there is one terminal device 130 in the started-up state, the image forming apparatus 110 first closest to this terminal device 130 is set to the power-on state.

For example, when the terminal device A of FIG. 30 is in the started-up state, the image forming apparatus A first closest to the terminal device A is set to the power-on state.

(Determination Method 2)

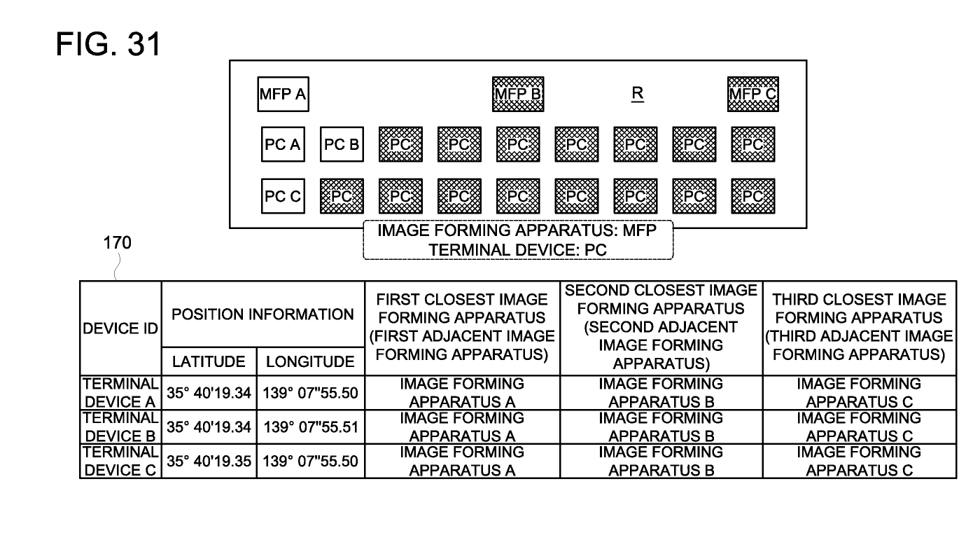

FIG. 31 shows an example of the image forming apparatus 110 to be set to the power-on state when one image forming apparatus 110 is first closest to each of all the terminal devices 130 in the started-up state and the number of the terminal devices 130 in the started-up state is smaller than a prescribed number.

The prescribed number is any desired number. It can be the initial set value registered in the server device 150 in advance or a desired number (a prescribed number) set and registered in the server device 150 in advance by the administrator or the like. Alternatively, the prescribed number can be determined based on the processing capacity of the image forming apparatus 110. For example, if the processing capacity of one image forming apparatus 110 is balanced with the processing amount of the job received from N units of terminal devices 130 (processing capacity of one image forming apparatus 110≈processing amount of the job received from N units of terminal devices 130), then that number N can be used as the prescribed number. In the following description, the prescribed number is assumed to be “4”.

If one image forming apparatus 110 is first closest to each of all the terminal devices 130 in the started-up state, and the number of the terminal devices 130 in the started-up state is less than four (two or three), the image forming apparatus 110 first closest to these terminal devices 130 is set to the power-on state.

For example, if the terminal device A, terminal device B and terminal device C of FIG. 31 are already in the started-up state, the image forming apparatus A is first closest to these terminal devices A through C. Thus, the image forming apparatus A is set to the power-on state.

(Determination Method 3)

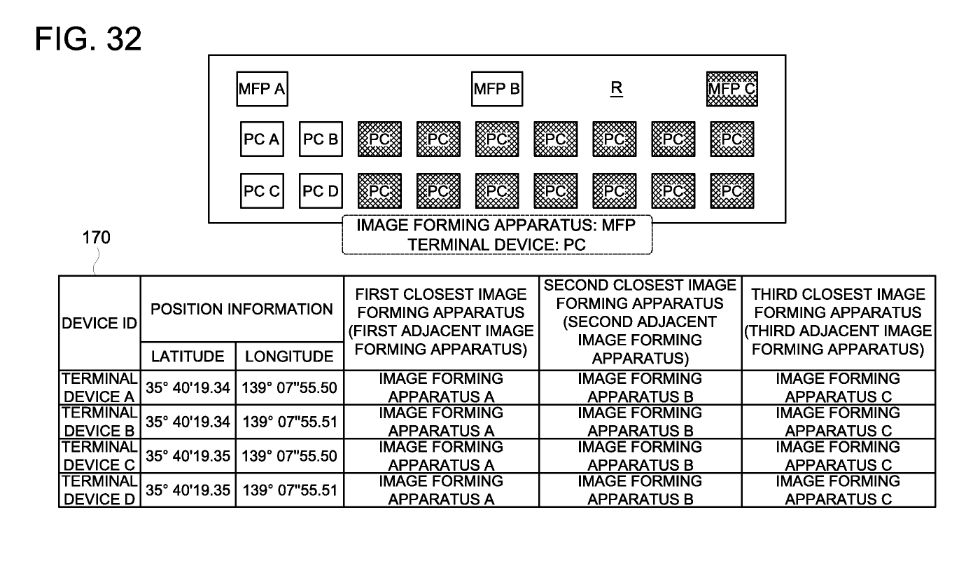

FIG. 32 shows the image forming apparatus 110 to be set to the power-on state when one image forming apparatus 110 is first closest to each of all the terminal devices 130 in the started-up state, and the number of these terminal devices 130 in the started-up state is equal to or greater than the prescribed number.

When one image forming apparatus 110 is first closest to each of all the terminal devices 130 in the started-up state, and the number of these terminal devices 130 in the started-up state is equal to or greater than four, the image forming apparatus 110 second closest to these terminal device 130 as well as the image forming apparatus 110 first closest thereto are set to the power-on state.

For example, if the terminal device A, terminal device B, terminal device C and terminal device D of FIG. 32 are already in the started-up state, the image forming apparatus A is first closest to these terminal devices A through D, and the image forming apparatus B is the second closest. Thus, the image forming apparatus A and image forming apparatus B are set to the power-on state.

When one image forming apparatus 110 is first closest to each of all the terminal devices 130 in the started-up state and the number of these terminal device 130 in the started-up state is equal to or greater than the prescribed number, the number of the image forming apparatus 110 to be set to the power-on state can be determined in conformity to the number of these terminal devices 130 in the started-up state. For example, it is also possible to make such arrangements that the second prescribed number (for example, seven) greater than the prescribed number (for example, four) is set for the terminal device 130 in the started-up state, and one image forming apparatus 110 is first closest to each of all the terminal devices 130 in the started-up state. If the number of these terminal devices 130 in the started-up state is equal to or greater than the second prescribed number, the image forming apparatus 110 first closest to these terminal devices 130 and the second closest image forming apparatus 110, as well as the third closest image forming apparatus 110 can be set to the power-on state.

If there are plural image forming apparatuses 110 second or third closest to these terminal devices 130, the image forming apparatus 110 second closest to the greatest number of the terminal devices 130 out of these terminal devices 130 or the image forming apparatus 110 third closest to the greatest number of the terminal devices 130 out of these terminal devices 130 can be set to the power-on state.

(Determination Method 4)

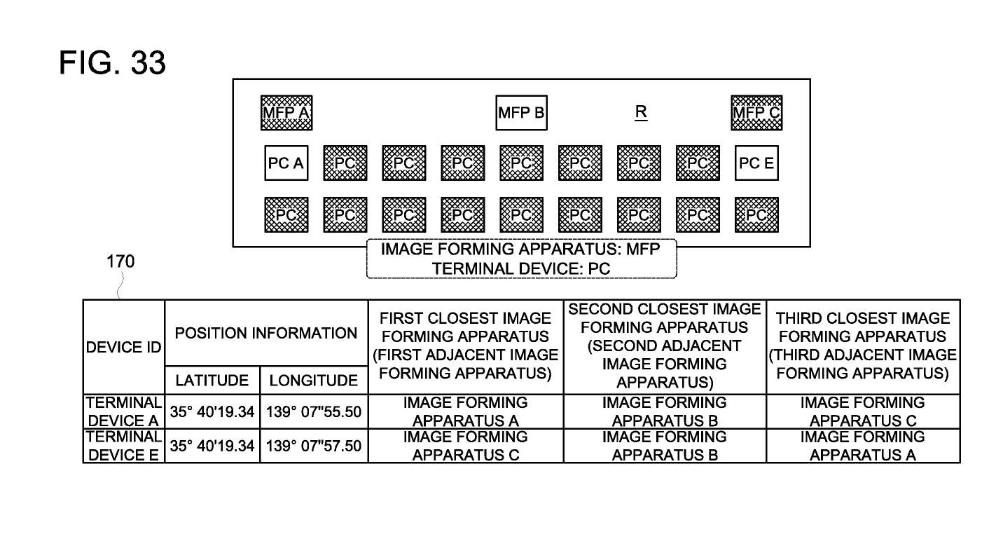

FIG. 33 shows an example of the image forming apparatus 110 to be set to the power-on state when one image forming apparatus 110 is not first closest to each of all the terminal devices 130 in the started-up state and there is an image forming apparatus 110 intermediate between these terminal devices 130 in the started-up state.

In this case, the aforementioned intermediate image forming apparatus 110 is set to the power-on state. The term “intermediate” refers to the area intermediate between terminal devices 130, the vicinity thereof, a space between terminal devices 130, and the surrounding area including the space between terminal devices 130. To be more specific, if there is an image forming apparatus 110 in the area intermediate between the terminal devices 130 or the vicinity thereof, this image forming apparatus 110 is set to the power-on state. Even if there is no image forming apparatus 110 in the area intermediate between terminal devices 130 or the vicinity thereof, if there is an image forming apparatus 110 between the terminal devices 130 or the surrounding area thereof, this image forming apparatus 110 is set to the power-on state.

For example, when the terminal device A and terminal device E of FIG. 33 are in the started-up state, the image forming apparatus A is the first closest to the terminal device A, and the image forming apparatus C is the first closest to the terminal device E. Thus, different image forming apparatuses are first closest to the terminal devices A and E. In this case, the image forming apparatus B located intermediate between the terminal device A and terminal device E is set to the power-on state. In FIG. 33, the image forming apparatus B is located in the vicinity of intermediate between the terminal device A and terminal device E, and the distance between the terminal device A and image forming apparatus B is almost the same as the distance between the terminal device E and image forming apparatus B.

There are various methods for selection of the intermediate image forming apparatus 110, based on the information on the positions of the terminal device 130 in the started-up state and image forming apparatus 110. The following illustrates the method for using the position of center of gravity of the terminal devices 130 in the started-up state, and the method for using the distance between the terminal device 130 in the started-up state and image forming apparatus 110:

(1) Position of center of gravity . . . The position of center of gravity of plural terminal devices 130 in the started-up state is obtained from the position information of these terminal devices 130, and the intermediate image forming apparatus 110 is selected based on the position of center of gravity.

(1-1) The image forming apparatus 110 closest to the center of gravity is selected as an intermediate image forming apparatus 110 (selected in order of increasing distance from the center of gravity).

(1-2) When the image forming apparatus 110 closest to the center of gravity is apart from the terminal device 130 by more than a prescribed distance, the image forming apparatus 110 is excluded from the candidates for the intermediate apparatuses, and selection is repeated out of the remaining image forming apparatuses 110 (with the exception of the image forming apparatuses 110 apart from the terminal device 130 by more than a prescribed distance, the image forming apparatus 110 closest to the center of gravity is selected out of the remaining image forming apparatuses 110 (selection is made from among the remaining image forming apparatuses 110 in order of increasing distance from the center of gravity).

(1-3) With the exception of the terminal device 130 apart from the center of gravity by more than a prescribed distance (terminal device 130 of singularity), the center of gravity is calculated again based on the position information of the remaining terminal devices, and the image forming apparatus 110 closest to the center of gravity is selected as an intermediate image forming apparatus 110 (selection is made in order of increasing distance from the center of gravity).

(2) Distance . . . The distance between each terminal device 130 and each image forming apparatus 110 is obtained from the position information of plural terminal devices 130 in the started-up state and the position information of each of the image forming apparatuses 110, and the intermediate image forming apparatus 110 is selected based on this distance.

(2-1) The image forming apparatus 110 having the smallest distance between each terminal device 130 and the image forming apparatus 110 is selected as the intermediate image forming apparatus 110 (selection is made in order of increasing distance).

(2-2) The distance is checked in order of increasing total distance between each terminal devices 130 and the image forming apparatus 110. The image forming apparatus 110 when the difference in the distance between each of the terminal devices 130 and image forming apparatuses 110 does not exceed the allowable value is selected as the intermediate image forming apparatus 110 (selection is made in order of increasing total distance for the image forming apparatus satisfying a condition that the difference in distance does not exceed the allowable value). The allowable value can be an absolute value, or can be a percentage with reference to the average distance between terminal devices 130 and the image forming apparatus 110.

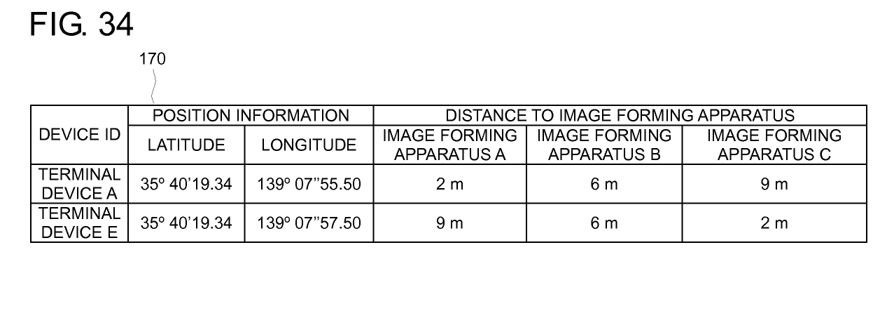

FIG. 34 shows a specific example where the image forming apparatus 110 wherein the difference in the distance between each terminal device 130 and the image forming apparatus 110 according to (2-1) is the smallest is selected as the intermediate image forming apparatus 110. In this example, two terminal devices A and E are in the started-up state, and the distance is calculated from the position information of these terminal devices A and E and image forming apparatuses A, B and C, and registered in the database 170. As shown in the drawing, the distances between the terminal device A and image forming apparatuses A, B and C are 2 m, 6 m and 9 m, respectively. The distances between the terminal device E and image forming apparatuses A, B and C are 9 m, 6 m and 2 m, respectively. In this case, the image forming apparatus B wherein the difference between distances of the terminal devices A and E to the image forming apparatus is the smallest is selected as the intermediate image forming apparatus 110.

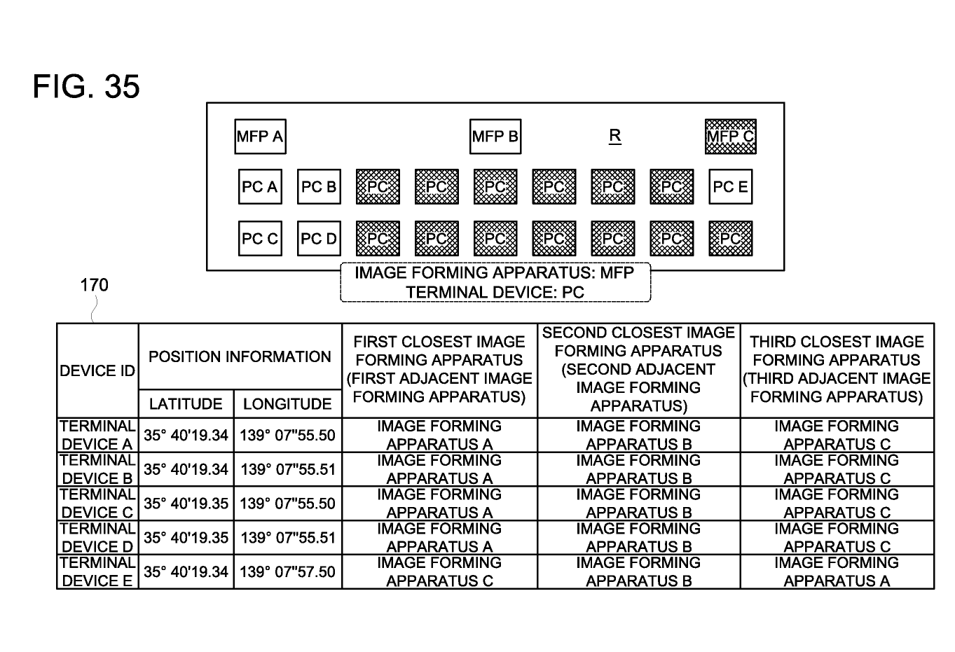

FIG. 35 shows an application example of the method 4 for determining the image forming apparatus 110 located intermediate between the terminal devices 130 in the started-up state to be set to the power-on state.

FIG. 35 shows an example of the image forming apparatus 110 to be set to the power-on state when an image forming apparatus 110 is located intermediate between these terminal devices 130, without one and the same image forming apparatus 110 being first closest to each of all the terminal devices 130 in the started-up state, and the number of the terminal devices 130 to each of which one image forming apparatus 110 is first closest is equal to or greater than a prescribed number (four). The following describes a combination of the cases of FIG. 32 and FIG. 33.

As illustrated FIG. 35, there are five terminal devices A through E in the started-up state. The image forming apparatus A is first closest to four terminal devices A through D out of these five terminal devices. The image forming apparatus C is first closest to the remaining terminal device E. Further, the image forming apparatus second closest to the terminal devices A through D, and the image forming apparatus second closest to the terminal device E are the image forming apparatus B. The image forming apparatus B is located intermediate between the terminal devices A through D and the terminal device E. To put it another way, the image forming apparatus B is located intermediate between all the terminal devices in the started-up state A through E. In this case, the intermediate image forming apparatus B is set to the power-on state. Further, since there are a prescribed number of (four) terminal devices A through D to each of which the image forming apparatus A is first closest, the image forming apparatus A is also set to the power-on state.

(Determination Method 5)

Plural terminal devices 130 in the management area R are usually turned on or off independently of each other by each user. Thus, the number of the terminal devices 130 to be set to the started-up state or suspended state is increased or decreased one by one. For example, when all the terminal devices 130 within the management area R have been turned off, if the first terminal device 130 is turned on and is put into the started-up state, the image forming apparatus 110 first closest to this terminal device having been set to the power-on state is set to the power-on state by the Determination method 1. When another terminal device 130 is turned on after that, there is at least one image forming apparatus 110 which is already set to the power-on state.

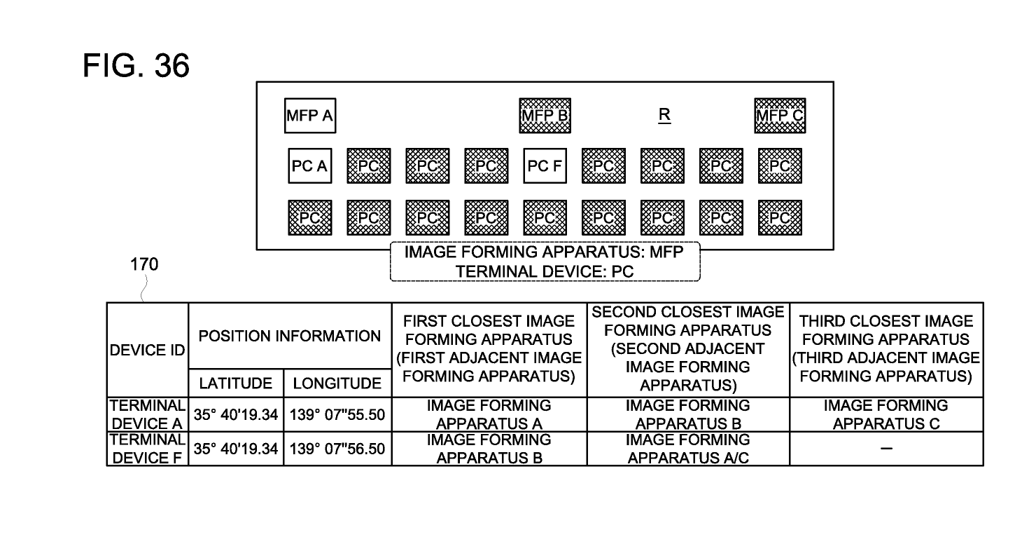

If there are plural terminal devices 130 in the started-up state without one image forming apparatus 110 being first closest to each of all the terminal devices 130 in the started-up state and without an image forming apparatus 110 located intermediate between all these terminal devices 130 in the started-up state, the image forming apparatus 110 already set to the power-on state is employed continuously. FIG. 36 shows the determining method 5 with reference to the example where two terminal devices 130 in the started-up state are present.

For example, in the case where all the terminal devices 130 within the management area R of FIG. 36 are turned off, when the terminal device A is turned on and is put into the started-up state, the image forming apparatus A first closest to the terminal device A is set to the power-on state according to the Determination method 1. Then when the terminal device F is turned on and is put into the started-up state, the image forming apparatus B is first closest to the terminal device F. One and the same image forming apparatus 110 is not first closest to each of the two terminal devices A and F in the started-up state, without any image forming apparatus 110 located intermediate between the terminal devices A and F. In this case, the image forming apparatus A already set to the power-on state continues to be employed in the power-on state.

(Determination Method 6)

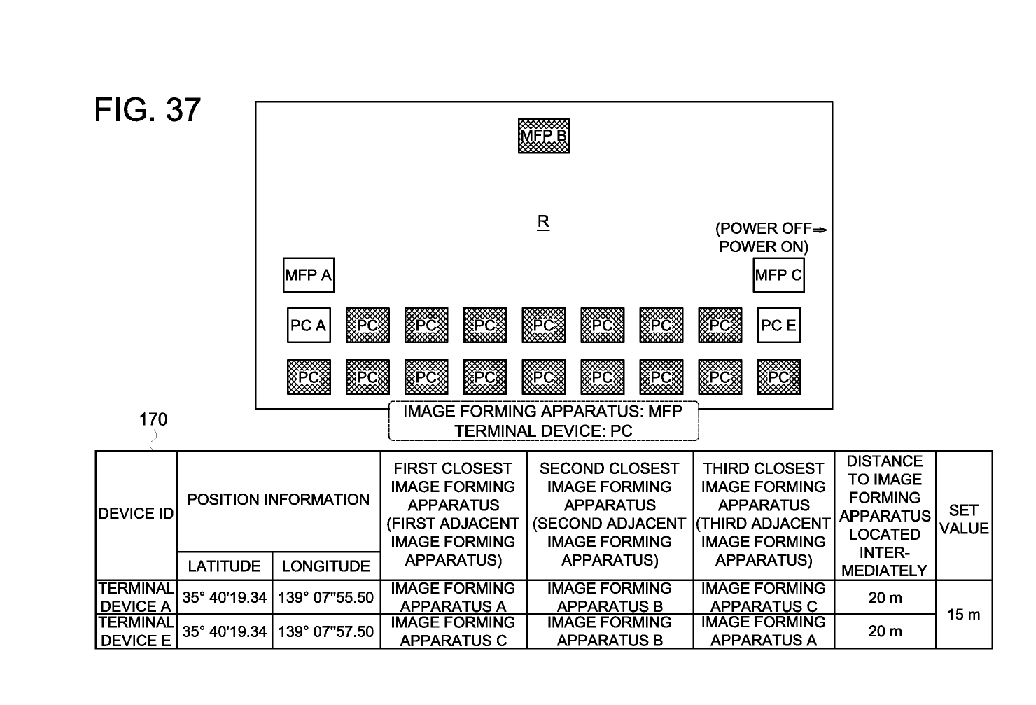

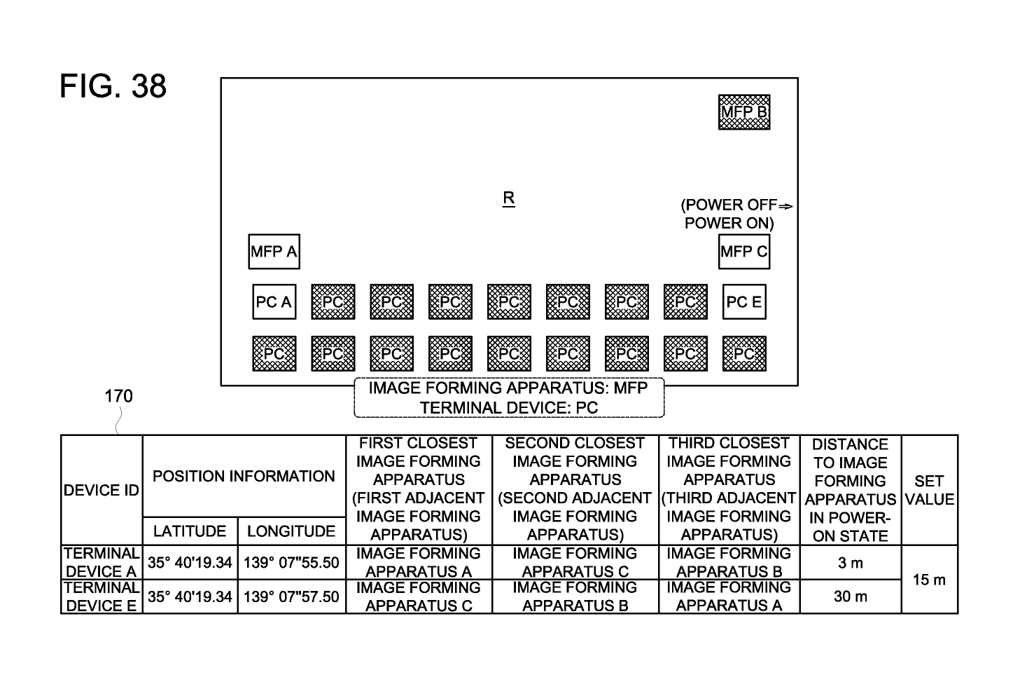

FIG. 37 and FIG. 38 show the case where the image forming apparatus 110 not closest to the terminal device 130 in the started-up state and apart by more than a prescribed distance is excluded from the candidate for the image forming apparatus 110 related to the terminal device 130 to be set to the power-on state. The prescribed distance is a desired distance (a prescribed distance) set and registered in advance by an administrator or the like in the server device 150. For example, when the prescribed distance is set at 15 meters, the server device 150 registers the preset value of 15 meters as a setting, as shown in the databases 170 of FIG. 37 and FIG. 38.

In the example of FIG. 37, two terminal device A and terminal device E are in the started-up state. The image forming apparatus A is first closest to the terminal device A, and the image forming apparatus C is first closest to the terminal device E. The image forming apparatus B is located intermediate between the terminal device A and terminal device E. However, when the intermediate image forming apparatus B is located apart from the terminal device A and terminal device E by a prescribed distance or more, the image forming apparatus B is excluded from the candidate of the image forming apparatus 110 related to these terminal devices A and E to be set to the power-on state.

In this example, both the distance between the terminal device A and image forming apparatus B, the distance between the terminal device E and image forming apparatus B are 20 meters, which is greater than the prescribed distance, 15 meters. Therefore, the image forming apparatus B is excluded from the candidate of the image forming apparatus 110 related to these terminal devices A and E to be set to the power-on state.

In this case, since the image forming apparatus B intermediate between the terminal devices A and E has been excluded, the image forming apparatus A first closest to the terminal device A and the image forming apparatus C first closest to the terminal device E are set to the power-on state.

In the example of FIG. 38, under the condition that all the terminal devices 130 within the management area R are turned off, when the terminal device A is turned on and is put into the started-up state, the image forming apparatus A first closest to the terminal device A is set to the power-on state according to Determination method 1. When the terminal device E is turned on and is put into the started-up state, the image forming apparatus C is first closest to the terminal device E. One and the same image forming apparatus 110 is not first closest to each of the two terminal devices A and E in the started-up state. There is no image forming apparatus 110 between the terminal devices A and E. In this example, the image forming apparatus B is located at a place other than intermediate between the terminal device A and terminal device E (apart from the position intermediate between the terminal device A and terminal device E).

In this case, the image forming apparatus A already set to the power-on state continues to be used in the same power-on state according to the aforementioned Determination method 5. However, the distance between the terminal device E and image forming apparatus A is 30 meters and is more than 15 meters that is the set value of the prescribed distance. Thus, the image forming apparatus A is excluded from the candidate for the image forming apparatus 110 related to the terminal device E to be set to the power-on state.

In this case, since the image forming apparatus A is excluded for the terminal device E, the image forming apparatus C first closest to the terminal device E is also set to the power-on state.

Independently of whether there is an increase or decrease in the number of the terminal devices 130 in the started-up state, to be more specific, when there is a change in the position and number of the terminal devices 130 in the started-up state, the image forming apparatus 110 to be set to the power-on state is again selected out of plural image forming apparatuses 110 according to the new information on the position and number of the terminal device 130 in the started-up state and the position information of each image forming apparatus 110.

For example, in FIG. 32, when one through three of the four terminal devices A through D in the started-up state have been turned off and put into the suspended state, the image forming apparatus B is set to the power-off state and the image forming apparatus A alone is set to the power-on state. In FIG. 33, when the terminal device E out of the two terminal devices A and E in the started-up state is turned off and put into to the suspended state, the image forming apparatus B is set to the power-off state and the image forming apparatus A is set to the power-on state (as shown in FIG. 30). In FIG. 35, when two or three of the terminal devices A through D out of five terminal devices A through E in the started-up state are turned off and put into the suspended state, the image forming apparatus A is set to the power-off state and the image forming apparatus B alone is set to the power-on state.

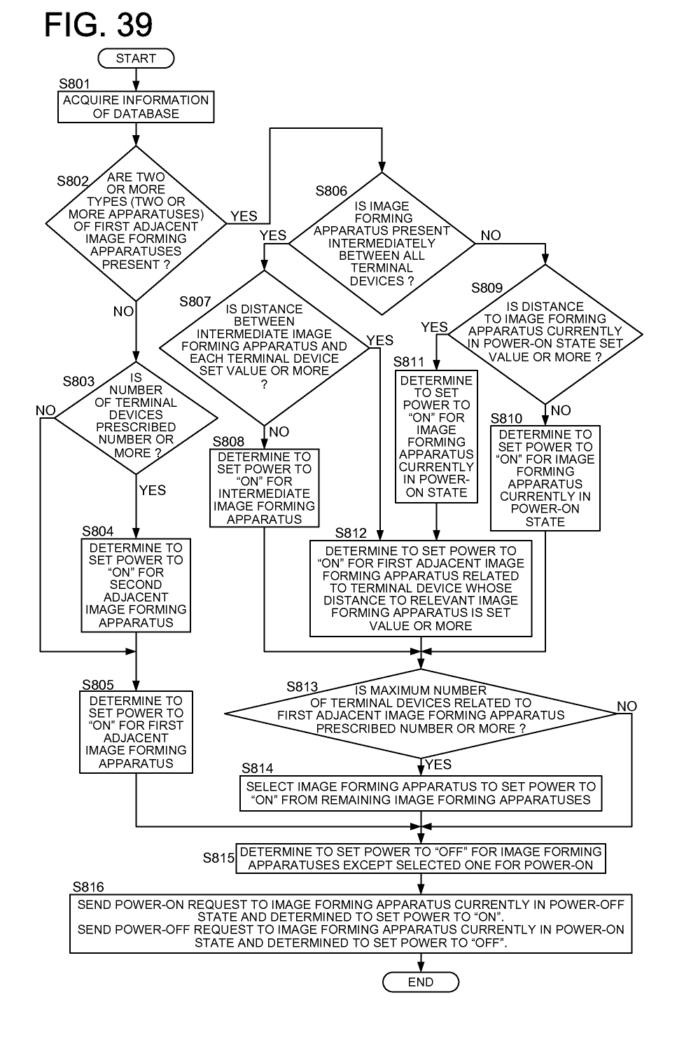

FIG. 39 is a flow chart showing the details of the determination method of Step S405 in FIG. 28, detailed contents of the transmission by the Step S406 in FIG. 28, the determination method of Step S505 in FIG. 29, and detailed contents of the transmission by the Step S506 in FIG. 29. The detailed determination methods of FIG. 39 cover the Determination methods 2 through 6 out of the aforementioned Determination methods 1 through 6.

The CPU 151 of the server device 150 acquires the information registered in the database 170 (Step S801). To put it in more detail, the CPU 151 acquires the information on the number and position of all the terminal devices 130 (all the terminal devices 130 in the started-up state) registered in the database 170, and the information on the first through third adjacent image forming apparatuses (first through third closest image forming apparatuses 110) (Step S801). When there is one image forming apparatus as the first adjacent image forming apparatuses (one common apparatus) (Step S802: No), the CPU 151 checks the number of the terminal devices 130 (all the terminal devices 130 in the started-up state) acquired from the database 170.

When the number of the terminal devices 130 is below a prescribed number (Step S803: No), the first adjacent image forming apparatus is determined to be set to the power-on state (Step S805), and the operation goes to the Step S815. This flow corresponds to the Determination method 2 (FIG. 31).

When the number of the terminal devices 130 is a prescribed number or more (Step S803: Yes), the second adjacent image forming apparatus is determined to be set to the power-on state (Step S804), and the first adjacent image forming apparatus is determined to be set to the power-on state (Step S805). Then the operation goes to Step S815. This flow corresponds to the Determination method 3 (FIG. 32).

As described above, when the number of the terminal devices 130 in the started-up state is equal to or greater than the second prescribed number (seven, for example) which is equal to or greater than a prescribed number (four, for example), another third adjacent image forming apparatus can be set to the power-on state. As described above, when there are plural types (units) of apparatuses of the second adjacent image forming apparatuses or third adjacent image forming apparatuses, the maximum number of the second adjacent image forming apparatuses or third adjacent image forming apparatuses can be determined to be set to the power-on state.

When there are two types (units) of the first adjacent image forming apparatuses (Step S802: Yes), the CPU 151 acquires the position information of the image forming apparatus 110 registered in the database 160. Based on the position information of all the terminal devices 130 in the started-up state and the position information of the image forming apparatus 110, the CPU 151 checks whether or not there is an image forming apparatus 110 intermediate between all the terminal devices 130 in the started-up state (Step S806). If there is an intermediate image forming apparatus 110 (Step S806: Yes), the CPU 151 verifies the distance between the intermediate image forming apparatus 110 and each terminal device 130 (Step S807).

If there is no terminal device 130 whose distance from the intermediate image forming apparatus 110 is equal to or greater than the set value (Step S807: No), the intermediate image forming apparatus 110 is determined to be set to the power-on state (Step S808), and the operation goes to Step S813. This flow corresponds to the Determination method 4 (FIG. 33).

If there is any terminal device 130 whose distance from the intermediate image forming apparatus 110 is equal to or greater than the set value (Step S807: Yes), the first adjacent image forming apparatus related to the terminal device 130 (whose distance from the intermediate image forming apparatus 110 is equal to or greater than the set value) is determined to be set to the power-on state (Step S812), and the operation goes to Step S813. This flow corresponds to the Determination method 6 (FIG. 37).

If there is no intermediate image forming apparatus 110 (Step S806: No), the distance between the image forming apparatus 110 currently in the power-on state and each terminal device 130 is verified (Step S809).

If there is no terminal device 130 whose distance from the image forming apparatus 110 in the power-on state is equal to or greater than the set value (Step S809: No), the image forming apparatus 110 currently in the power-on state is determined to be used continuously in the same power-on state (Step S810), and operation goes to the Step S813. This flow corresponds to the Determination method 5 (FIG. 36). If there is any terminal device 130 whose distance from the image forming apparatus 110 in the power-on state is equal to or greater than the set value (Step S809: Yes), the image forming apparatus 110 currently in the power-on state is determined to be used continuously in the same power-on state (Step S811). The first adjacent image forming apparatus related to the terminal device 130 (whose distance from the image forming apparatus 110 currently in the power-on state is equal to or greater than the set value) is determined to be set to the power-on state (Step S812), and the operation goes to Step S813. This flow corresponds to the Determination method 6 (FIG. 38).

In Step S813, the CPU 51 checks whether or not the number of the terminal devices 130 related to the first adjacent image forming apparatuses the greatest number of terminal devices (the first adjacent image forming apparatus for the greatest number of terminal devices 130 in the power-on state) out of the first adjacent image forming apparatuses obtained from the database 170 is equal to or greater than a prescribed number (Step S813).

If the number of the terminal devices 130 related to the first adjacent image forming apparatuses of the greatest number of terminal devices is less than a prescribed number (Step S813: No), the operation goes to Step S815. If the number of the terminal devices 130 related to the first adjacent image forming apparatuses of the greatest number of terminal devices is equal to or greater than a prescribed number (Step S813: Yes), an appropriate image forming apparatus 110 is selected out of the remaining image forming apparatuses 110 without being determined to be set to the power-on state and is determined to be set to the power-on state (Step S814). The operation goes to Step S815.

In Step S814, for example, if the aforementioned first adjacent image forming apparatuses of the greatest number of terminal devices are not determined to be set to the power-on state in any one of the Steps S810, S811 and S812, the first adjacent image forming apparatuses of the greatest number of terminal devices can be determined to be set to the power-on state. Further, if the number of the terminal devices 130 related to the first adjacent image forming apparatuses of the greatest number of terminal devices is equal to or greater than the second prescribed number greater than a prescribed number, and the second adjacent image forming apparatus by the terminal devices 130 related to the first adjacent image forming apparatuses the greatest number of terminal devices (the second adjacent image forming apparatuses of the greatest number of terminal devices when there are more than one type) does not overlap the image forming apparatus 110 intermediate therebetween already determined to be set to the power-on state or the image forming apparatus 110 currently in the power-on state for continued use, the second adjacent image forming apparatus can be determined to be set to the power-on state.

If the aforementioned first adjacent image forming apparatus of the greatest number of terminal devices have been determined to be set to the power-on state in any one of the Steps S810, S811 and S812, the second adjacent image forming apparatus of the terminal devices 130 related to the first adjacent image forming apparatuses of the greatest number of terminal devices can be determines to be set to the power-on state. Further, if there are plural second adjacent image forming apparatuses, the second adjacent image forming apparatuses of the greatest number of terminal devices out of the plural second adjacent image forming apparatuses can be determined to be set to the power-on state.

Of plural image forming apparatuses 110 registered in the database 160, the image forming apparatuses 110 other than the image forming apparatuses 110 having been determined to be set to the power-on state are determined by the CPU 151 to be set to the power-off state (Step S815). The CPU 151 verifies the power state of each of the image forming apparatuses 110 registered in the database 160, and sends a power-on request to the image forming apparatuses 110 which are currently in the power-off state and have been determined to be set to the power-on state. The CPU 151 sends a power-off request to the image forming apparatuses 110 which are currently in the power-on state and have been determined to be set to the power-off state (Step S816/End).

In Step S816, the image forming apparatus 110 to which the power transition request is to be sent is identified. Then the power transition request is sent to this image forming apparatus 110. However, it is also possible to make such arrangements that a power transition request is sent to all the image forming apparatuses 110, and the power transition request is ignored by the image forming apparatus 110 already in the power-on state.

Having received the power-on request from the server device 150, the image forming apparatus 110 in the power-off state performs the operation of transition to the power-on state. Having received the power-off request from the server device 150, the image forming apparatus 110 in the power-on state performs the operation of transition to the power-off state. In the transition to the power-off state, if there is any job currently being processed or on a waiting list, transition to the power-off state can be started after termination of this job.

It is also possible to make such arrangements that the image forming apparatus 110 that can be used is notified to the terminal device 130 in the started-up state. For example, when the image forming apparatus 110 in the power-off state is set to the power-on state or the image forming apparatus 110 in the power-on state is set to the power-off state, the information on the image forming apparatus 110 subjected to transition of power state can be notified to the terminal device 130 in the started-up state.

When the server device 150 (management server) also serves as an print server, it is also possible to arrange such a configuration that the server device 150 receives a printing job from the terminal device 130, and the image forming apparatus 110 that is located first closest to the terminal device 130 among the image forming apparatuses 110 that can be used is specified as the output destination so that a printed output is conducted by this image forming apparatus 110. Then the information on this mage forming apparatus 110 is notified to the terminal device 130.

As described above, in this Example, the server device 150 related to the example provides power control in such a way that the image forming apparatus 110 to be set to the power-on state is selected (and determined) out of plural image forming apparatuses 110, based on the information on the position and number of the terminal devices 130 in the started-up state, and the position information of each image forming apparatus 110 and the selected image forming apparatus 110 is then set to the power-on state. Further, under this power control, the image forming apparatus 110 not selected as an apparatus to be set to the power-on state is set to the power-off state. This arrangement ensures the power-on state to be set on the number (the optimum number) of the image forming apparatuses 110 so located as to ensure easy use from the terminal device 130 in the started-up state with this number being optimized based on the number of the terminal devices 130 in the started-up state. This arrangement enhances convenience for the user of the terminal device 130 in the started-up state to employ the image forming apparatus 110, and reduces the power consumption of the image forming apparatus 110, and improves the operation efficiency.

Especially when one and the same image forming apparatus 110 is not closest to each of all the terminal devices 130 in the started-up state in the management area R, the image forming apparatus 110 intermediate therebetween is set to the power-on state for the terminal devices 130 in the started-up state. This ensures the power-on state to be set on the image forming apparatus 110 of a high degree of fairness from the viewpoint of distance from all the terminal devices 130 in the started-up state within the management area R.

When there is one and the same image forming apparatus 110 closest to each of a prescribed number or more of terminal devices 130 in the started-up state, this image forming apparatus 110 is set to the power-on state. This arrangement ensures the power-on state to be set on the image forming apparatus 110 which is most adjacent to each of a prescribed number or more of the terminal devices 130 in the power-on state and which is so located as to ensure easy use for many users (a prescribed number or more of users). Further, for example, if the image forming apparatus 110 is set to the power-on state for less than the aforementioned prescribed number (a smaller number) of the terminal devices 130, the processing capacity of the image forming apparatus 110 will be excessive for the processing amount of the job received from less than a prescribed number of terminal devices 130. This may cause the power of the image forming apparatus 110 to be wasted, or the operation efficiency to be reduced. Thus, the image forming apparatus 110 is set to the power-on state for the aforementioned prescribed number or more of the terminal devices 130. This prevents the processing capacity of the image forming apparatus 110 from becoming excessive for the number (a prescribed number of more) of terminal devices 130 in the started-up state. This also prevents the power of the image forming apparatus 110 from being wasted, and minimizes the reduction of the operation efficiency.

When one image forming apparatus 110 is closest to each of all the terminal devices 130 in the started-up state within the management area R, this image forming apparatus 110 is set to the power-on state. This ensures the power-on state to be set on one common image forming apparatus 110 which is closest to the users of all the terminal devices 130 in the started-up state and is easy to use.

The image forming apparatus 110 which is not most adjacent to the terminal device 130 in the started-up state and is apart therefrom by a prescribed distance or more is excluded from the candidates for the image forming apparatus 110 related to the terminal device 130 to be set to the power-on state. This prevents the power-on state from being set on the image forming apparatus 110 which is so located as to cause difficulties in use from the terminal device 130.

Further, when there is change in the position or number of the terminal devices 130 in the started-up state, the image forming apparatus to be set to the power-on state can be re-selected out of plural image forming apparatuses 110, based on the new information on the position and number of the terminal device 130 in the started-up state and the position of each image forming apparatus 110. This ensures immediate response to a possible change.

### Fourth Example

The following describes the power control of the image forming apparatus 110 in the fourth Example where the layouts of the image forming apparatus 110 and terminal device 130 within the management area R of the server device 150 are different from those in the third Example (FIG. 23, etc.).

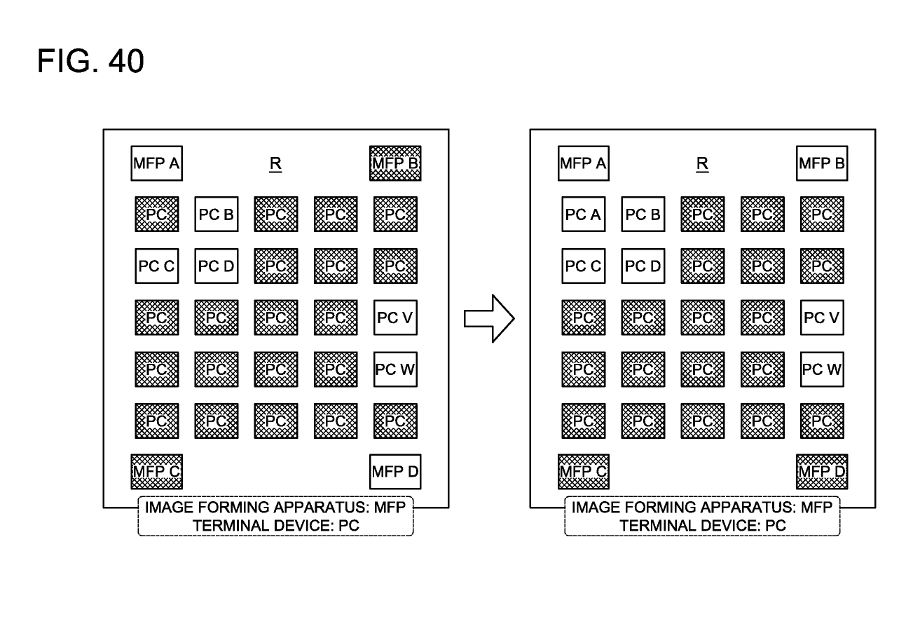

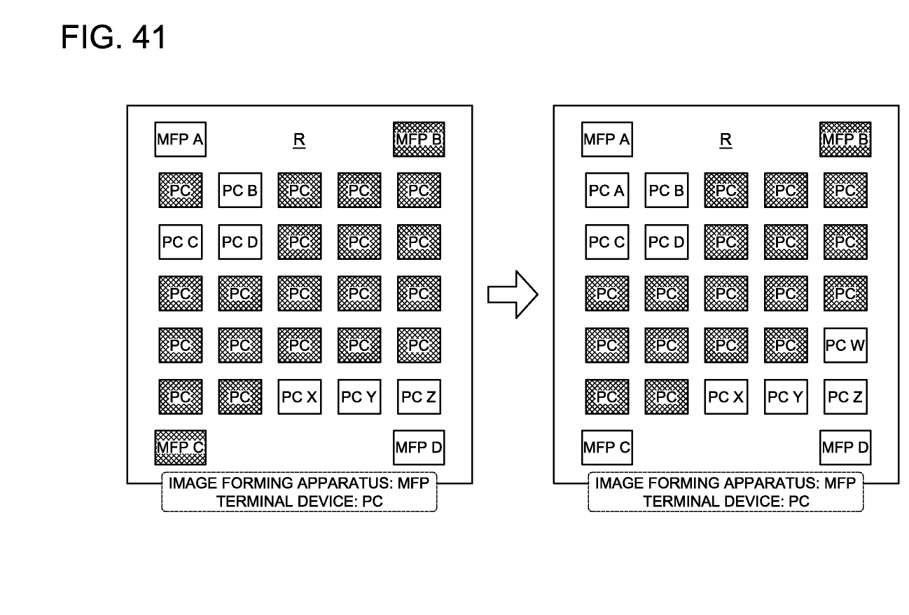

FIG. 40 and FIG. 41 shows the image forming apparatus 110 determined to be set to the power-on state for the terminal devices 130 in the started-up state within the management area R in the fourth Example. The management area R in the fourth Example accommodates four image forming apparatuses 110 (image forming apparatuses A through D) and multiple (25 for example) terminal devices 130. The terminal devices 130 are adjacent to each other, and arranged in plural rows and columns (a matrix of five rows and five columns, for example). The image forming apparatuses 110 are laid out apart from each other by a prescribed distance around the terminal devices 130 (for example, at four corners of the management area R).

In FIG. 40, when three terminal devices B through D to each of which the image forming apparatus A is closest and two terminal devices V and W to each of which the image forming apparatus D is closest are in the started-up state (the image forming apparatus B and image forming apparatus D are closest to the terminal device V), the image forming apparatus A and image forming apparatus D are set to the power-on state. After that, when the terminal device A to which the image forming apparatus A is closest is turned on and is set to the power-on state, the image forming apparatus to be set to the power-on state is determined again.

In this Example, image forming apparatuses 110 closest to each of a prescribed number or more of the terminal devices 130 in the started-up state is determined as a specific image forming apparatus. A second prescribed number of the terminal devices 130 to each of which this specific image forming apparatus is closest are determined as attributed terminal devices wherein the second prescribed number is equal to or greater than the prescribed number. The image forming apparatuses 110 to be set to the power-on state are determined for the terminal devices 130 in the started-up state except all the attributed terminal devices.

To put it more specifically, the image forming apparatus A which is closest to each of four terminal devices A throughput D is determined as a specific image forming apparatus. Three (three or more are acceptable if there are many terminal devices) out of terminal devices A through D to each of which this specific image forming apparatus is closest are determined as the attributed terminal devices. For example, three terminal devices A through C are determined as attributed terminal devices. For the terminal devices A through C determined as attributed terminal devices, the closest image forming apparatus A is determined to be set to the power-on state. Then the image forming apparatus 110 to be set to the power-on state is determined for the terminal devices in the started-up state D, V and W except all the attributed terminal devices (terminal devices A through C).

In this case as well, it is possible to arrange such a configuration that the image forming apparatus 110 intermediate between the terminal devices D, V and W is determined to be set to the power-on state or, if there is no intermediate image forming apparatus 110, the image forming apparatus 110 second closest to the greatest number of terminal devices out of the terminal devices D, V and W is determined to be set to power-on state. Here, the image forming apparatus B intermediate between the terminal devices D, V and W is set to the power-on state, and the image forming apparatus D having been in the power-on state is set to the power-off state.

As described above, the image forming apparatus 110 which is closest to each of a prescribed number or more of the terminal devices 130 in the started-up state (image forming apparatus A) is determined as a specific image forming apparatus, and the second prescribed number of the terminal devices 130 to each of which this specific image forming apparatus is closest are determined as the attributed terminal devices (for example, terminal devices A through C) wherein the second prescribed number is equal to or greater than the aforementioned prescribed number (prescribed number=3 in FIG. 40). When the image forming apparatus 110 (image forming apparatus B) to be set to the power-on state is selected for the terminal devices 130 in the started-up state except all the attributed terminal devices (for example, terminal devices D, V and W), a sufficient number of image forming apparatuses with respect to the number of the terminal devices 130, so located as to ensure easy use from the terminal devices 130 in the started-up state except all attributed terminal devices can be set to the power-on state.

In FIG. 41, when three terminal devices B through D to each of which the image forming apparatus A is closest and three terminal devices X through Z to each of which the image forming apparatus D is closest are in the started-up state (wherein the image forming apparatus C and image forming apparatus D are closest to the terminal device X), the image forming apparatus A and image forming apparatus D are set to the power-on state. After that, if the terminal device A closest to the image forming apparatus A and the terminal device W closest to the image forming apparatus D are turned on and put into the started-up state, a new image forming apparatus 110 to be set to the power-on state is determined again.

In this case, the image forming apparatus 110 which is closest to each of a prescribed number or more of the terminal devices 130 in the started-up state is determined as a specific image forming apparatus. The image forming apparatus 110 to be set to the power-on state is determined for surplus terminal devices which are the terminal devices 130 to each of which the first specific image forming apparatus is closest, except the second prescribed number of terminal devices, and for surplus terminal devices which are the terminal devices 130 to each of which the second specific image forming apparatus is closest, except the second prescribed numbers of terminal devices, wherein the second prescribed number is equal to or greater than the prescribed number.

To put it more specifically, the image forming apparatus A and image forming apparatus D each of which is closest to each of four terminal devices (terminal devices A through D/terminal device W through Z) are determined as specific image forming apparatuses, and the image forming apparatus A is determined as the first specific image forming apparatus temporarily, and the image forming apparatus D is determined as the second specific image forming apparatus tentatively. The closest image forming apparatus A is determined to be set to the power-on state for three (three or more are acceptable when there are many terminal devices) tentatively out of the terminal devices A through D to each of which the image forming apparatus A as the first specific image forming apparatus is closest. The extra terminal device except these three is determined as the surplus terminal device (for example, terminal device D). The closest image forming apparatus D is determined to be set to the power-on state for three (three or more are acceptable when there are many terminal devices) tentatively out of the terminal devices W throughput Z to each of which the image forming apparatus D as the second specific image forming apparatus is closest. The extra device except these three is determined as the surplus terminal device (for example, terminal device X). Then the image forming apparatus 110 to be set to the power-on state is determined for the surplus terminal devices (for example, terminal devices D and X).

In this case as well, the image forming apparatus 110 intermediate between the surplus terminal devices (for example, terminal devices D and X) can be determined to be set to the power-on state or, if there is no intermediate image forming apparatus 110, the image forming apparatus 110 second closest to each of the greatest number of surplus terminal devices out of all the surplus terminal devices can be determined to be set to the power-on state. Here the image forming apparatus C second closest to each of the terminal device D and terminal device X is set to the power-on state.

As described above, the image forming apparatuses closest to each of a prescribed number or more of the terminal devices 130 in the started-up state (image forming apparatuses A and D) are determined as the specific image forming apparatuses. When selecting the image forming apparatus 110 to be set to the power-on state for the surplus terminal device (for example, terminal device D) which is the terminal devices (terminal devices A through D) to each of which the first specific image forming apparatus (image forming apparatus A) is closest except the second prescribed number of terminal devices, wherein the second prescribed number is equal to or greater than the prescribed number (the prescribed number=3 in FIG. 41), and for the surplus terminal device (for example, terminal device X) which are the terminal devices (terminal devices W through Z) to each of which the second specific image forming apparatus (image forming apparatus D) is closest except the second prescribed number of terminal devices, wherein the second prescribed number is equal to or greater than the prescribed number, a sufficient number with respect to the number of the surplus terminal devices, of image forming apparatuses so located as to ensure easy use from each surplus terminal device can be set to the power-on state for each of the surplus terminal devices.

The Examples of the present invention have been described so far with reference to diagrams. It is to be understood that the specific configuration is not restricted thereto. The present invention can be embodied in a number of variations with appropriate modification or additions, without departing from the spirit and scope of the present invention.

For example, in the first and second Examples, when the information processing terminal 30 is turned on, the power state transition request is sent. However, timing of executing this operation is not restricted thereto. For example, the power state transition request can be sent when the driver program of the image forming apparatus 10 has been started or a document creating application program has been started. Further, it is also possible to arrange such a configuration that the timing of operation for sending a power state transition request can be set as desired.

Further, the selection determining method of the closest image forming apparatus is not restricted to methods shown with reference to the above embodiments. For example, it is also possible to use the procedure where information on the room and passage layout (map information) is registered, and the path used for walking between the image forming apparatus 10 and information processing terminal 30 and the distance walked through this path (route) are calculated, whereby the closest image forming apparatus is selected and determined. Further, it is also possible to make such arrangements that a prescribed score is assigned in conformity to the distance and route, and points are added to this score. For example, if a different room is used, one point is added to this score. If a different floor is used, two points per one floor difference are added to this score. The apparatus having the smallest total score is selected and determined as the closest image forming apparatus.

Further, the closest image forming apparatus can be selected and determined by giving consideration to other factors such as the processing capacity and function of the image forming apparatus.

The information processing terminal 30 is preferably configured to send a job such as a printing job to the image forming apparatus selected and determined as the closest image forming apparatus in the operation of sending a power state transition request.

In the third and fourth Examples, for example, the layout and number of plural image forming apparatuses 110 and plural terminal devices 130 within the management area of the server device 150 are not restricted to the ones shown in the embodiments. Further, the method of selecting the image forming apparatus to be set to the power-on state out of plural image forming apparatuses 110 is not restricted to the methods described with reference to the aforementioned embodiments.

Without being restricted to an installation type desk top PC, the terminal device 130 can be a portable notebook PC. The portable terminal device 130 can be configured to communicate with the image forming apparatus 110 and server device 150 through the network of wireless LAN.

The position information of the terminal device 130 and position information of the image forming apparatus 110 can be inputted and registered into the database by the administrator in advance, without being obtained from each device to be registered by the server device 150.

Power control can be made in such a way that the image forming apparatus 110 not selected as the image forming apparatus to be set to the power-on state out of plural image forming apparatuses 110 is set to the power saving state, without being set to the power-off state as described with reference to the aforementioned embodiments.

It is possible to set up a prescribed area different from the management area R managed by the server device 150 as described with reference to the aforementioned embodiments in the configuration where, when one image forming apparatus 110 is not closest to each of all the terminal devices 130 in the started-up state within a prescribed area, the image forming apparatus 110 intermediate therebetween is set to the power-on state for the terminal devices 130 in the started-up state, and in the configuration where, when one image forming apparatus is closest to each of all the terminal devices 130 in the started-up state within a prescribed area, the image forming apparatus 110 is set to the power-on state. For example, an area centering the image forming apparatus 110 is set and this area can be the aforementioned prescribed area.

The image forming apparatus illustrated in FIG. 40 closest to each of prescribed number or more of the terminal device in the started-up state is determined as a specific image forming apparatus, and the second prescribed number of the terminal devices closest to the this specific image forming apparatus are determined as attributed terminal devices wherein the second prescribed number is equal to or greater than a prescribed number. Further, the image forming apparatus to be set to the power-on state is selected for the terminal devices in the started-up state except all the attributed terminal devices. In this configuration, if the image forming apparatus to be set to the power-on state is selected for terminal devices other than the attributed terminal devices, the image forming apparatus intermediate therebetween can be selected as the image forming apparatus to be set to the power-on state.

The image forming apparatus according to the embodiments of the present invention can be applied to a printer device and facsimile device without being restricted to the multi-functional peripheral described with reference to the embodiments.

The information processing terminal and power state management apparatus according to the embodiments of the present invention ensure the transition of the power to the power-on side in an image forming apparatus so located as to ensure easy use from the current position of an information processing terminal (for example, located at the closest position thereto).

Further, the power state management apparatus according to the embodiments of the present invention ensures the power-on state to be set on an appropriate number optimized based on the number of the terminal devices in the started-up state, of the image forming apparatuses so located as to ensure easy use from the terminal device in the started-up state. This structure minimizes the power consumption of the image forming apparatus and improves the operation efficiency, while enhancing convenience for the user of the terminal device in the started-up state when employing an image forming apparatus.

What is claimed is:

1. A power state management apparatus comprising:
a first position information acquiring section for acquiring information on a position of an information processing terminal in a started-up state, which includes a function of sending a job to an image forming apparatus through a network;
a second position information acquiring section for acquiring information on a position of each of image forming apparatuses linked to the network;
a selecting section for selecting the image forming apparatus in which a power state is to be changed to a power-on side from among the image forming apparatuses, based on the information on the position of the information processing terminal in the started-up state acquired by the first position information acquiring section and the information on the position of each of the image forming apparatuses acquired by the second position information acquiring section; and
a transmission section for sending a request to change the power state to the image forming apparatus selected by the selecting section.

2. The power state management apparatus of claim 1
wherein the selecting section selects the image forming apparatus closest to the information processing terminal in the started-up state.

3. The power state management apparatus of claim 1
wherein the selecting section performs the selection after priority order of a first image forming apparatus has been reduced below priority order of a second image forming apparatus, when a difference in elevation between the information processing terminal in the started-up state and the first image forming apparatus is equal to or greater than a reference value and a difference in elevation between the information processing terminal and the second image forming apparatus is smaller than the reference value.

4. The power state management apparatus of claim 1
wherein one or a plurality of areas are set for an real space, and the selecting section performs the selection after priority order of the image forming apparatus present in a same area as the information processing terminal in the started-up state is placed above priority order of the image forming apparatus present in another area.

5. A power state management apparatus comprising:
a first acquiring section for acquiring information on a position and a number of terminal devices in a started-up state which have a function of sending a job to an image forming apparatus through a network;
a second acquiring section for acquiring information on a position of a plurality of image forming apparatuses linked to the network; and
a control section for selecting the image forming apparatus to be turned on from among the plurality of image forming apparatuses and for providing power control of turning on the selected image forming apparatus, based on the information on the position and the number of the terminal devices in the started-up state acquired by the first acquiring section, and the information on the position of each of the plurality of image forming apparatuses acquired by the second acquiring section.

6. The power state management apparatus of claim 5
wherein, one or a plurality of areas are set for an real space, and when one image forming apparatus is not closest to each of all the terminal devices in the started-up state in a prescribed area, the control section selects an intermediate image forming apparatus for the terminal devices in the started-up state as the image forming apparatus to be set to a power-on state.

7. The power state management apparatus of claim 5
wherein, when one image forming apparatus is closest to each of a prescribed number or more of terminal devices in the started-up state, the control section selects the one image forming apparatus as the image forming apparatus to be set to a power-on state.

8. The power state management apparatus of claim 7
wherein the image forming apparatus closest to each of the prescribed number or more of the terminal devices in the started-up state is assumed to be a specific image forming apparatus, and the second prescribed number of the terminal devices to each of which the specific image forming apparatus is closest are assumed to be attributed terminal devices, the second prescribed number being equal to or greater than the prescribed number, and the control section selects the image forming apparatus to be set to a power-on state for the terminal devices in the started-up state except all the attributed terminal devices.

9. The power state management apparatus of claim 7
wherein the image forming apparatus closest to each of the prescribed number or more of the terminal devices in the started-up state is assumed to be a specific image forming apparatus, and the control section selects the image forming apparatus to be set to a power-on state for surplus terminal devices which are terminal devices to each of which a first specific image forming apparatus is closest except a second prescribed number of terminal devices, the second prescribed number being equal to or greater than the prescribed number for the first specific image forming apparatus, and for surplus terminal devices which are terminal devices to each of which a second specific image forming apparatus is closest except a second prescribed number of terminal devices, the second prescribed number being equal to or greater than the prescribed number for the second specific image forming apparatus.

10. The power state management apparatus of claim 5
wherein, one or a plurality of areas are set for an real space, and when one image forming apparatus is closest to each of all the terminal devices in the started-up state in a prescribed area, the control section selects the one image forming apparatus as the image forming apparatus to be set to a power-on state.

11. The power state management apparatus of claim 5
wherein the image forming apparatus which is not closest to the terminal device in the started-up state and is away therefrom by at least a prescribed distance is excluded, by the control section, from a candidate of the image forming apparatus to be set to a power-on state in relation to the terminal device.

12. The power state management apparatus of claim 5
wherein, if there is a change in the position or the number of the terminal devices in the started-up state acquired by the first acquiring section, the control section re-selects the image forming apparatus to be set to a power-on state, out of the plurality of image forming apparatuses, based on updated information on the position and the number of the terminal devices in the started-up state and the information on the position of each of the plurality of image forming apparatuses.

13. The power state management apparatus of claim 5
wherein the control section provides power control in such a way as to ensure that, out of the plurality of image forming apparatuses, the image forming apparatus not having been selected as the image forming apparatus to be set to a power-on state is changed to a power-off state.

14. An information processing terminal having a function of sending a job to an image forming apparatus through a network, the information processing terminal comprising:
a detecting section for detecting a distance between the information processing terminal and each of image forming apparatuses linked to the network;
a selecting section for selecting the image forming apparatus in which a power state is to be changed to a power-on side from among the image forming apparatuses, based on the distance detected by the detecting section; and
a transmission section for sending a request to change the power state to the image forming apparatus selected by the selecting section.

15. The information processing terminal of claim 14
wherein the detecting section comprises:
a first position information acquiring section for acquiring information on a position of the information processing terminal; and
a second position information acquiring section for acquiring information on a position of the image forming apparatus,
wherein the detecting section detects the distance based on the information on the position of the information processing terminal acquired by the first position information acquiring section and the information on the position of the image forming apparatus acquired by the second position information acquiring section.

16. The information processing terminal of claim 14
wherein the selecting section selects the image forming apparatus closest to the information processing terminal.

17. The information processing terminal of claim 14
wherein the selecting section conducts the selection after a first image forming apparatus is given lower order of priority than a second image forming apparatus, when a difference in elevation between the information processing terminal and the first image forming apparatus is equal to or greater than a reference value and a difference in elevation between the information processing terminal and the second image forming apparatus is below the reference value.

18. The information processing terminal of claim 14
wherein one or a plurality of areas are set for real space, and the selecting section performs the selection after the image forming apparatus located in a same area as the information processing terminal is given higher order of priority than the image forming apparatus located in another area.
